(19) United States
(12) Patent Application Publication
(10) Pub. No.: US 2024/0417573 A1
(43) Pub. Date: Dec. 19, 2024

(54) A METHOD FOR PREPARING AN ANTI-FOULING POLYMERIC COATING

(71) Applicant: McMaster University, Hamilton (CA)

(72) Inventors: Ryan Wylie, Toronto (CA); Alexander Jesmer, Upper Kingsclear (CA); Vincent Hyunh, Maple (CA)

(21) Appl. No.: 18/700,799

(22) PCT Filed: Oct. 12, 2022
(86) PCT No.: PCT/CA2022/051499

§ 371 Date: Apr. 12, 2024

Related U.S. Application Data
(60) Provisional application No. 63/254,613, filed on Oct. 12, 2021.

(51) Int. Cl. C09D 5/16; C09D 7/20

(52) U.S. Cl. CPC C09D 5/1675; C09D 5/1681; C09D 7/20

(57) ABSTRACT

The present disclosure relates to a method for preparing an anti-fouling polymeric coating on a substrate.

### CROSS-REFERENCE TO RELATED APPLICATIONS

This application claims the benefit of priority to U.S. Provisional Application No. 63/254,613, filed Oct. 12, 2021, the contents of which is incorporated herein by reference in its entirety.

### FIELD

The present disclosure is directed to antifouling polymeric coatings, and in particular, to antifouling polymeric coatings with sensor capabilities.

### BACKGROUND

Antifouling polymeric coatings are commonly created by grafting pre-synthesized polymers onto device surfaces,^{1,2} a method referred to as “graft-to”, to minimize nonspecific interactions and foreign body responses initiated by medical devices³ as well as to improve the performance of water contacting and marine materials by preventing biofilm formation. There is therefore a great need to improve the performance of antifouling polymer coatings for many applications. Antifouling polymer coatings on biointerfaces remains an active area of research that is particularly important for biosensors where detectable signals are limited by background noise from nonspecific binding and bulk shifts.^{4,5} To improve antifouling properties of graft-to polymer coated surfaces, previous work has primarily focused on the discovery of new antifouling polymers and anchoring mechanisms,⁶ or through grafting of structures such as microgels.⁷

### SUMMARY

The present disclosure is directed to a method for preparing an anti-fouling polymeric coating on a substrate. In particular, the disclosure includes a method for preparing an anti-fouling polymeric coating on a substrate having a surface area, the method comprising:
(i) increasing the surface area of the substrate;
(ii) functionalizing the substrate with one or more first functional moieties;
(iii) grafting to the substrate one or more pre-synthesized polymers, wherein the polymer comprises one or more second functional moieties which is complementary to the first functional moiety and reacts to form a bond between the substrate and the polymer; and
(iv) reducing the surface area of the substrate thereby increasing the density of the polymers on the substrate,
thereby obtaining the anti-fouling polymeric coating on the substrate.

In another embodiment, the present disclosure is directed to a biomedical device coated with an anti-fouling coating as prepared by a method of the disclosure. In one embodiment, the device is a catheter, a reconstructive or cosmetic elastomer, an elastomer coated metal or ceramic implant, or an implanted biosensor.

In another embodiment, the device comprises a substrate, such as polystyrene, which is functionalized with a film of gold, and upon heating the polystyrene above its glass transition temperature, the film of gold wrinkles to form active micro and nano-wrinkles thereby increasing the density of the polymers on the substrate, and wherein the device is a plasmonic sensor.

In another embodiment of the disclosure, there is included a method to improve surface coverage of antifouling polymers and, optionally, simultaneously generate high surface area plasmonic metal-based sensors, the method comprising:
a. grafting polymers directly onto a shrinkable, expandable or stretchable substrate or depositing a thin film of plasmonic material onto a shrinkable substrate followed by grafting polymers onto the shrinkable, expandable or stretchable substrate;
b. shrinking the substrate:
   wherein shrinking results in increased polymer density to improve antifouling properties of bio interfaces and wrinkling of the plasmonic metal forms active micro and nano-wrinkles for sensing

In some embodiments, the plasmonic metal comprises but is not limited to gold, silver or platinum,

In some embodiments, the plasmonic metal-based sensing comprises but is not limited to localized surface plasmon resonance (LSPR), surface-enhanced Raman scattering (SERS), electrochemical based sensors

In some embodiments, the shrinkable, expandable or stretchable substrates comprise but are not limited to polystyrene, Polytetrafluoroethylene (PTFE), polydimethylsiloxane (PDMS), polyolefin, low density polyethylene (LDPE), polyvinylchloride (PVC)

In an embodiment, heating above the glass transition temperature of the substrate shrinks the footprint of the substrate to increase the density of the polymer and wrinkle the plasmonic metal layer

In some embodiments, the polymers comprise antifouling hydrophilic polymers

In some embodiments, the polymers comprise but are not limited to (poly(carboxy betaine) (PCB) or poly(carboxy betaine-co-N-(3-aminopropyl) methacrylamide) (PCB-co-APMA)), Poly(oligo (ethylene glycol) methyl ether methacrylate) (POEGMA), polysulfobetaine, poly(2-methacryloyloxyethyl phosphorylcholine), poly trimethylamine N-oxide) copolymerized with a functionalizable monomer including but not limited to APMA

In some embodiments, the polymers are functionalized with surface reactive groups, and optionally, with capture ligands covalently immobilized on polymer coatings for the detection of an analyte

In some embodiments, the surface reactive groups comprise, but are not limited to thiols, 3,4-dihydroxyphenylalanine (DOPA), and/or click handles such as azide alkyne

In an embodiment, a device is provided with improved antifouling surface properties compatible with biomedical applications such as implants and/or an antifouling device with intrinsic sensor capabilities.

Other features and advantages of the present application will become apparent from the following detailed description. It should be understood, however, that the detailed description and the specific examples, while indicating embodiments of the application, are given by way of illustration only and the scope of the claims should not be limited by these embodiments, but should be given the broadest interpretation consistent with the description as a whole.

### DRAWINGS

The embodiments of the application will now be described in greater detail with reference to the attached drawings in which:

FIG. 1, in one embodiment, shows Graft-then-shrink: Simultaneous improvement of polymer surface coverage for antifouling properties and generation of LSPR active Au surfaces in an exemplary embodiment of the application. a) Structure of thiol terminated PCB for grafting to the Au layer. b) Prestressed, PS discs were sputter coated with thin Au layers (<10 nm) and functionalized with pre-made thiol-terminated polymers. The density of the polymers was limited by the polymer's radius of gyration (Rg). The PS-Au-PCB surfaces were then heated to 130° C. to shrink the PS discs and wrinkle the Au layer, which simultaneously improves polymer surface coverage to enhance antifouling properties and generates LSPR active wrinkled Au surfaces, producing Graft-then-Shrink surfaces. Control surfaces of Shrink-then-Graft where PS discs coated in thin Au layers were shrunk prior to PCB grafting. SEM of surfaces and fluorescence micrograph of adhered cells to c) Graft-then-Shrink and d) Shrink-then-Graft surfaces depicting polymer-induced wrinkle size differences and resistance to nonspecific cell adhesion on Graft-then-Shrink surfaces. e) Photograph of Au coated PS before and after shrinking with heat. f) Schematic of plate layout of fluidic sensor devices in a 96 well plate. g) Representative sensorgram produced by Graft-then-Shrink sensors depicting functionalization of the surface with a capture agent, rinsing, and binding of a corresponding biomolecule to the immobilized capture agent.

FIG. 2, in one embodiment, shows PCB content is greater on Graft-then-Shrink Au surfaces in an exemplary embodiment of the application. a) Relative absorbance upon PCB quantification using the BCA assay for the detection of PCB's amide bonds on surfaces with the same footprint. Comparison of the amount of 60 kDa PCB on flat (unwrinkled), Shrink-then-Graft, Graft-then-Shrink under dry conditions, and Graft-then-Shrink under wet conditions (mean±SD, n=3). Flat Au surfaces were prepared by first shrinking PS prior to Au sputtering. b) XPS of 60 kDa PCB coatings on Shrink-then-Graft and Graft-then-Shrink dry surfaces compared to bare (no PCB) wrinkled surfaces (bare shrink) of equal surface area. Graft-then-Shrink dry had a greater N signal than Shrink-then-Graft and bare shrink, indicating greater PCB content in a defined footprint. Au signals were greatest on bare shrink surfaces due to the lack of PCB overlayer.

FIG. 3, in one embodiment, shows SEM micrographs of wrinkled Au surfaces from Shrink-then-Graft and Graft-then-Shrink (dry and wet) with immobilized PCB of various MWs in an exemplary embodiment of the application. Shrink-then-Graft surfaces with immobilized a) 10 kDa, b) 25 kDa, and c) 60 kDa polymers. Graft-then-Shrink dry surfaces with d) 10 kDa, e) 25 kDa, and f) 60 kDa PCB polymers. Graft-then-Shrink wet surfaces with g) 10 kDa, h) 25 kDa, and i) 60 kDa PCB polymers. j) Wrinkled Au surface without PCB. Scale bar=1 μm. K) Heat map of wrinkle length distributions of structured surfaces. 1) Characteristic wrinkle lengths of structured surfaces (mean±SE, n=60 to 100 wrinkles), large flat (unwrinkled) regions were not included in measurements. m) WCAs of 3 μL MilliQ water drops on bare and PCB coated flat (unwrinkled) and wrinkled surfaces (mean±SD, n=3).

FIG. 4, in one embodiment, shows Graft-then-Shrink improved resistance to nonspecific macrophage adhesion in an exemplary embodiment of the application. Macrophage adhesion to 5 nm Au surfaces modified with PCB of three different MWs under high fouling experimental conditions. Surfaces were soaked in 100% aged bovine serum for 48 hours for maximum nonspecific protein adsorption, followed by macrophage exposure for 24 hours. a) Average number of adhered macrophages per mm2 for each surface type (mean±SD, n=6). b) Representative fluorescent micrographs of Calcein AM stained RAW 264.7 macrophages. Scale bar=250 μm.

FIG. 5, in one embodiment, shows Sensitivity characterization of bare (no PCB) and PCB coated wrinkled Au LSPR sensors in an exemplary embodiment of the application. a) Representative raw and fit absorbance spectra of bare 5 nm Au in PBS and alcohol solvents. Circles denote peak location (maximum absorbance) on fitted data. b) Peak absorbance locations of 2.5, 3.7, 5 and 7.5 nm Au in MeOH, EtOH, IPA and BuOH. c) Compiled sensitivities of bare Au sensors in alcohol and aqueous glucose solutions (mean±SD, n=3). d) Compiled sensitivities of hydrophilic PCB coated 5 nm Au sensors in aqueous glucose solutions (mean±SD, n=3).

FIG. 6, in one embodiment, shows sensing avidin binding/unbinding with polymer coated LSPR sensors in an exemplary embodiment of the application. a) LSPR peak shift of Graft-then-Shrink dry surfaces from avidin immobilization via EDC/NHS onto PCB and POEGMA surfaces (mean±SD, n=2 or 3). b) A sensorgram of peak absorbance shifts over time of a 5 nm Au film fabricated using Graft-then-Shrink with 10 kDa PCB-co-APMA (30% APMA content). The “No Ligand” control shows no response to avidin: PCB-co-APMA was not modified with biotin or desthiobiotin. The “Ligand” condition includes a ˜3 nm increase in peak absorbance wavelength following exposure of the biotinylated surface to avidin (10-5 M) in PBS. The injection sequence for both sensors was: (1a) Biotin-NHS in 4:1 PBS:DMF, (1b) 4:1 PBS:DMF without Biotin-NHS, (2) 0.1 M butylamine, (3) PBS, (4) avidin (10-5 M) in PBS, (5) PBS. c) Overlaid sensorgrams of PBS, avidin pre-saturated with biotin, and free avidin using a sensor modified with biotin, demonstrating minimal nonspecific binding of pre-saturated avidin. d) Overlaid sensorgrams of Graft-then-Shrink sensors with 10 kDa PCB-co-APMA (30% APMA) functionalized with either NHS-biotin or NHS-desthiobiotin: (1) association of avidin (10-5 M) and (2) dissociation of avidin in either PBS or a biotin solution (10-3 M). Maximum peak absorbance shifts are normalized to illustrate the different dissociation rates from different ligands and dissociation buffers.

FIG. 7, in one embodiment, shows Graft-then-Shrink LSPR sensors are concentration sensitive in an exemplary embodiment of the application. a) Sensorgram of 10 kDa PCB-co-APMA (30 mol % APMA) covalently functionalized with biotin-NHS and exposed to solutions of increasing avidin concentrations in 10 mM HEPES buffer supplemented with 1% BSA. b) Average (+SD, SD is variation in signal from a single sensor) LSPR peak location from the sensorgrams in a): inset of dose response curve composed of peak shift on linear axes (average±SD, SD is variation in signal from a single sensor).

FIG. 8 is a ¹H NMR spectra of a CB-TBu monomer:

FIG. 9) is an NMR spectroscopic characterization, in one embodiment, of pCB-TBu synthesis from pDMAPMA. (A) Quantification of monomer percent modification by NMR. (B) Reaction scheme of pCB-TBu preparation. (C-E) H NMR of precursor pDMAPMA, protected pCB-TBu and deprotected pCB-COOH. (F) Structures and assignments of H NMR:

FIG. 10, in one embodiment, shows (A) Overview schematic of the Graft then shrink method using swelled elastomers, where swollen PDMS is functionalized with SMCC, then either deswelled before grafting thiol terminated polymers (“Shrink then graft” control) or deswelled after grafting thiol terminated polymers (“Graft then shrink”). (B) Structures of RAFT synthesized thiol terminated pOEGMA 2 mer, 4 mer and 8 mer, and pCB-TBu/COOH polymers. (C) Calculated Log P values of monomers corresponding to pOEGMA and pCB. (D) Swelling ratio with ethyl acetate and toluene of Sylgard™ 184 PDMS with 10:1 (1.95×) and 30:1 (3.87×) base:crosslinker ratio (mean±SD, n=3) by calculation of total surface area using calibrated photographs of top area and thickness, measured in ImageJ. (E) Photographs of PDMS in non-swollen and toluene swollen states. Scale bar=10 mm:

FIG. 11, in one embodiment, shows grafting thiol terminated pOEGMA onto swelled maleimide modified PDMS increases graft polymer content. (A) Fluorescence intensity by microscopy of 50 kDa POEGMA-co-fluorescein methacrylate (8 mer) copolymers grafted onto PDMS (mean±SD, n=3). Unfilled bars represent control elastomers that were either maleimide active with no fluorescent polymer exposure, or pristine PDMS exposed to fluorescent polymer. Filled bars represent elastomers that were both maleimide functional and exposed to thiol terminated fluorescent pOEGMA. (B) Confocal microscopy quantification of depth distribution of fluorescently labeled polymer near PDMS surfaces. (C) Calculated FWHM of the polymer distributions in (B):

FIG. 12, in one embodiment, shows Surface fluorescence of pOEGMA on PDMS. Grafting of fluorescent (A) 20 and (B) 100 kDa 8 mer pOEGMA to PDMS with and without maleimide functionalization.

FIG. 13, in one embodiment, shows Maleimide content of elastomers after polymer grafting. (A) Surface fluorescence of SMCC modified elastomers after reaction with a thiol-fluorescein tracer. (B) Maleimide content of elastomers before and after polymer grafting. Means±SD, n=3.

FIG. 14, in one embodiment, shows PDMS swelling solvent modulates polymer grafting content. Fluorescence intensity of (A) 10:1 and (B) 30:1 PDMS swelled in EtAc or toluene functionalized with pCB-COOH and pCB-TBu fluorescent copolymers and (C) 8 mer pOEGMA fluorescent copolymers (mean±SD, n=3).

FIG. 15, in one embodiment, shows pCB-TBu ester deprotection in pH 1.3 HCl. (A) Relative tert-butyl group signal by NMR after exposure to HCl at pH 1.3 for between 2 and 6 hours at room temperature and 50° C. (B) Calculated percent of ester deprotection based on relative signal from NMR of pCB-TBu. (C) Solution fluorescence intensity of pCB-TBu and pCB-COOH fluorescein methacrylate copolymers. Mean±SD, n=3.

FIG. 16, in one embodiment, show grafting salt choice and concentration modifies grafted pCB-COOH content. (A) Absorbance of elastomers at 502 nm modified with fluorescent pCB-COOH_{f} copolymers (mean±SD, n=3). Concentrations refer to MES or GHCl, polymer concentration was 2 mg mL-1 for all cases. (B, C) Photographs of grafting solution after polymer grafting procedure and 10:1 Graft then shrink elastomers grafted with fluorescent pCB-COOH_{f} copolymers in various buffers.

FIG. 17, in one embodiment, shows quantification of fluorescence of pCB copolymers grafted in MES and GHCl on PDMS. (A) Surface fluorescence of 10:1 PDMS elastomers modified with fluorescent pCB-COOH in MES and GHCl grafting buffers between 1 and 1000 mM. (B) Grafting solution fluorescence of 10:1 PDMS elastomers modified with fluorescent pCB in MES and GHCl grafting buffers between 1 and 1000 mM.

FIG. 18, in one embodiment, shows apparent molecular weight of pCB changes with GHCl concentration. (A) GPC of PEG standards and pCB-co-fluorescein methacrylate in three GHCl buffer concentrations. (B) Plotted apparent molecular weight of pCB as calculated by GPC calibrated with PEG standards in PBS.

FIG. 19, in one embodiment, shows macrophage adhesion to PDMS modified with non-antifouling polymers. (A) Cell adhesion of Raw 264.7 macrophages on 10:1 and 30:1 PDMS modified with 2 mer and 4 mer pOEGMA (mean±SD, n=3). (C) Ratio of cells adhered between Graft then shrink and Shrink then graft materials modified with 2 mer and 4 mer POEGMA.

FIG. 20, in one embodiment, graft then shrink with high M_{w} POEGMA onto swelled elastomers improves antifouling properties. (A, B) Cell adhesion of Raw 264.7 macrophages on 10:1 and 30:1 PDMS modified with pOEGMA and pCB-COOH polymers (mean±SD, n=3). (C) Representative images of cell adhesion on 10:1 PDMS modified with 100 kDa pOEGMA. Scale bar=1000 μm. Representative micrographs of all other conditions are shown in FIG. 21.

FIG. 21, in one embodiment, shows representative fluorescence micrographs of RAW 264.7 macrophage adhesion on polymer modified PDMS. Scale bar=1000 μm.

FIG. 22, in one embodiment, shows resistance of pOEGMA and pCB-COOH modified elastomers towards E. coli bacterial attachment. Live bacterial adhesion was characterized by culturing the elastomers in E. coli suspensions overnight and then gently rinsing the elastomers with sterile LB broth and incubating them in fresh LB broth overnight, allowing adhered bacteria to proliferate. OD600 values of the LB broth following overnight incubation with bacteria exposed (A) 10:1 and (B) 30:1 elastomers modified with pOEGMA and pCB-COOH was then measured (mean±SD, n=4).

FIG. 23, in one embodiment, shows graft then shrink on elastomers does not modify hydrophilicity. (A) Water contact angles of 3 μL droplets of Milli-Q water on pOEGMA modified (A) 10:1 and (B) 30:1 PDMS and pCB-COOH modified (C) 10:1 and (D) 30:1 PDMS elastomers. Mean±SD, n=4.

FIG. 24, in one embodiment, shows water contact angle measurements of polymer modified PDMS. (A) Representative images of 3 μL droplets of MilliQ water on PDMS samples. (B) Average water contact angle of PDMS samples. Mean±SD, n=4.

### DETAILED DESCRIPTION

### I. Definitions

Unless otherwise indicated, the definitions and embodiments described in this and other sections are intended to be applicable to all embodiments and aspects of the present application herein described for which they are suitable as would be understood by a person skilled in the art.

In understanding the scope of the present application, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

As used in this application, the singular forms “a”, “an” and “the” include plural references unless the content clearly dictates otherwise.

In embodiments comprising an “additional” or “second” component, the second component as used herein is chemically different from the other components or first component. A “third” component is different from the other, first, and second components, and further enumerated or “additional” components are similarly different.

The term “and/or” as used herein means that the listed items are present, or used, individually or in combination. In effect, this term means that “at least one of” or “one or more” of the listed items is used or present.

The term “anti-fouling” as used herein, refers to the polymeric coatings that have reduced binding of one or more of cells and/or other cellular material (such as protein).

The term “functionalizing” as used herein, refers to the introduction of functional moieties or groups onto the substrate or polymer.

The term “functional moiety” as used herein refers to chemical groups or moieties which are reactive with other complementary moieties to form bonds between the substrate and pre-synthesized polymers.

The term “grafting to” as used herein refers to grafting pre-synthesized polymers to a substrate (as opposed to monomers and polymerizing on the substrate).

The term “pre-synthesized polymers” refers to polymers and co-polymers which have been already polymerized and the pre-synthesized polymers are grafted to the substrate, as opposed to synthesizing the polymers on the substrate.

The term “complementary” as used herein refers to the reactivity of the first and second functional moieties and their ability to react with each other to link or bond the substrate with the pre-synthesized polymers.

The term “vinyl moiety” as used herein refers to a complementary moiety containing the chemical group-CH═CH₂.

The term “amine moiety” as used herein refers to a complementary moiety containing the chemical group-NH₂.

The term “azide moiety” as used herein refers to a complementary moiety containing the chemical group-N₃.

The term “alkyne moiety” as used herein refers to a complementary moiety containing the chemical group-C≡CH.

The term “maleimide moiety” as used herein refers to a complementary moiety containing the chemical group

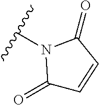 [SMILES: *N1C(=O)C=CC1=O]

The term “plasmonic metal” as used herein refers to a metal capable of supporting a surface plasmon when exposed to light of the appropriate wavelength.

The term “zwitterionic polymer” as used herein refers to a polymer containing both positively and negatively charged moieties within each monomeric unit.

The term “hydrophilic polymer” as used herein refers to a polymer which is partially, or fully, soluble in water.

### II. Detailed Description

The present disclosure is directed to a method for preparing an anti-fouling coating, and devices made therefrom.

In one embodiment of the disclosure, there is provided a method for preparing an anti-fouling polymeric coating on a substrate having a surface area, the method comprising:
(i) increasing the surface area of the substrate;
(ii) functionalizing the substrate with one or more first functional moieties;
(iii) grafting to the substrate one or more pre-synthesized polymers, wherein the polymer comprises one or more second functional moieties which is complementary to the first functional moiety and reacts to form a bond between the substrate and the polymer, or the polymer and substrate associate through intermolecular interactions; and
(iv) reducing the surface area of the substrate thereby increasing the density of the polymers on the substrate, thereby obtaining the anti-fouling polymeric coating on the substrate.

In one embodiment, the polymer and the substrate associate through intermolecular interactions, such as ionic interactions, Van der waals interactions or hydrophobic interactions. In one embodiment, the intermolecular interaction is a hydrophobic interaction.

In one embodiment, the substrate may have a three-dimensional shape (such as in the form of a catheter), and therefore, both the surface area and the volume of the substrate is increased in step (i).

In one embodiment, the substrate is a crosslinked polymer. In another embodiment, the crosslinked polymer is an elastomer. In another embodiment, the elastomer is a siloxane elastomer or a polyurethane elastomer. In another embodiment, the polymer is an antifouling hydrophilic polymer.

In one embodiment, the substrate comprises polystyrene, polytetrafluoroethylene (PTFE), polydimethylsiloxane (PDMS), polyolefin, low density polyethylene (LDPE), polyvinylchloride (PVC) or polyurethane.

In another embodiment, the surface area of the substrate is increased by physical or chemical means. In another embodiment, the physical means comprises a mechanically-applied force, wherein the force is stretching the substrate, inflating the substrate, or by pre-stressing the substrate below its glass transition temperature.

In another embodiment, the chemical means comprise swelling the substrate in a suitable solvent. In another embodiment, the suitable solvent is an organic solvent capable of dissolving the elastomer. In another embodiment, the solvent is toluene or ethyl acetate. In another embodiment, a list of PDMS swelling solvents is taught in Lee, Park and Whitesides 2003 (See Table 1, “Solvent compatibility of Poly(dimethylsiloxane)-Based Microfluidic Devices” Analytical chemistry, 75 (23), pp. 6544-6554., herein incorporated by reference).

In another embodiment, the degree of surface area increase is controlled by the solvent, the degree of cross-linking of the substrate, or amount of physical stretching.

In another embodiment, wherein the first functional moiety comprises a thiol reactive plasmonic metal incorporated onto the substrate via sputter coating or a chemical moiety comprising a vinyl moiety, an amine moiety, an alkyne moiety, an azide moiety, or a maleimide moiety, incorporated onto the substrate through either direct addition of functional small molecules such as an aminosilane in the case of an amine functionality, or through grafting heterobifunctional molecules to otherwise functionalized substrates, such as a succinimidyl-4-(N-maleimidomethyl)cyclohexane-1-carboxylate onto an amine functional surface to provide maleimide functionality. In one embodiment, for example when the substrate is PDMS, the PDMS is functionalized with silanol groups by plasma oxidation using an inductively coupled plasma. To the silanol groups an amino silane ((such as 3-aminopropyl)triethoxysilane) is grafted, providing amine functionality to the surface, this amino silane is in an organic solvent (such as toluene or ethyl acetate) which both solubilizes the small molecule and swells the PDMS elastomer. In a further embodiment, the amine functionalized and swelled elastomer is functionalized with a maleimide moiety through the use of a heterobifunctional crosslinker with both maleimide and NHS-ester functionality.

In another embodiment, the first functional moiety comprises a hydrophobic surface, compound or moeity amenable to physisorption with a graft polymer containing a hydrophobic segment such as a DOPA or PDMS segment.

In another embodiment, the thiol reactive plasmonic metal is gold, silver or platinum and is applied to the substrate by sputter coating.

In another embodiment, the pre-synthesized polymer is zwitterionic polymer or a hydrophilic polymer. In an embodiment, the zwitterionic polymer is (poly(carboxy betaine) (PCB), polysulfobetaine, poly(2-methacryloyloxyethyl phosphorylcholine), poly(2-methacryloyloxyethyl phosphorylcholine) (PMPC), or poly-trimethylamine (N-oxide).

In another embodiment, the hydrophilic polymer is poly(ethylene glycol) (PEG), or poly(oligo(ethyleneglycol)methylethermethacrylate) (POEGMA).

In another embodiment, any of the pre-synthesized polymers is co-polymerized with a second monomer to form a pre-synthesized co-polymer, wherein the second monomer imparts functionality to the anti-fouling coating to allow for immobilization of biologically functional compounds, such as peptides or proteins to control cell interactions with implanted surfaces. In another embodiment, the second monomer can further control a drug release from the anti-fouling coating. In another embodiment, the second monomer can capture analytes and thereby the anti-fouling coating also acts as a specific recognition unit for application on sensor surfaces. In a further embodiment, the pre-synthesized polymer is a copolymer with N-(3-aminopropyl) methacrylamide (APMA) with any of the described polymers above. In another embodiment, the second monomer is derivatized with an analyte capturing functionality through the attachment of a specific recognition unit (i.e. a protein or aptamer or small molecule ligand), the sensing is done by the LSPR functional of the wrinkled gold with uv-vis spectroscopy.

In another embodiment, the analyte capturing functionality includes non-covalent protein-protein interactions such as a biotin ligand capturing an avidin protein, or a covalent capture between the functional polymer and a reactive analyte such as an azide modified small molecule reacting to a strained alkyne ligand.

In another embodiment of the disclosure, the second functional moiety is a thiol, 3,4-dihydroxy phenylalanine (DOPA), N-hydroxysuccinimide ester, an azide moiety, or alkyne terminated functional group. In another embodiment, thiol groups or moieties are complementary to gold, maleimide or vinyl moieties: DOPA is complementary to hydrophobic surfaces or moieties (a hydrophobic interaction): N-hydroxysuccinimide esters are complementary to amine functionalities: azide moieties are complementary to alkyne moieties and alkyne moieties are complementary to azide moieties.

In another embodiment, the surface area of the substrate is reduced by heating the substrate above the glass transition temperature or removing the mechanically applied force.

In a further embodiment, when the substrate is swelled with a solvent, the surface area of the substrate is reduced by evaporation or exchange of the solvent.

In another embodiment, the polymers are further functionalized with ligands to detect biological activity or capture an analyte.

In one embodiment, the substrate is polystyrene and the polystyrene is functionalized with a film of gold, and upon heating the polystyrene above its glass transition temperature, the film of gold wrinkles to form active micro and nano-wrinkles thereby increasing the density of the polymers on the substrate.

In another embodiment, substrates coated with wrinkled gold films using the method of the disclosure are plasmonically active, and such a surface is used for optical sensing by visible wavelength spectroscopy or by surface enhanced raman spectroscopy. In one embodiment, the visible wavelength absorbance spectra of the wrinkled gold is measured by a spectrometer over time while the sensor is exposed to solutions with and without a target analyte, wherein shifts in wrinkled gold absorbance spectrum are attributed to analytes within the local region of the surface. In one embodiment, the wrinkled gold film is a thin layer on the substrate, for example (between 1-10 nm, or about 5 nm) allowing some light to pass through the layer. In one embodiment, the absorbance spectrum of the surface, such as the gold surface, is determined, for example, by the refractive index of the medium close the surface. The dependence of the absorbance spectrum on the local refractive index is the principal which is used for sensing. In one embodiment, the absorbance spectrum on the sensor surface is measured over time as the sensor is exposed to different solutions with analytes, and when those analytes bind to the surface, they change the refractive index, thus shifting the absorbance spectrum, leading to a measurable signal for sensing purposes. In another embodiment, the noble metal sensing surface comprises plasmonic based localized surface plasmon resonance (LSPR), or surface-enhanced Raman scattering (SERS), or electrochemical based sensors. In one embodiment, gold is the noble metal, and LSPR is the optical sensing spectroscopy to indicate the presence of an analyte.

Accordingly, in one embodiment, there is included a method for sensing an analyte, the method comprising:
i) coating a substrate with the method of the disclosure, wherein the substrate comprises a polymer with an analyte capturing functionality;
ii) exposing the substrate to one or more analytes;
iii) measuring the refractive index of the substrate, and comparing the refractive index to a control substrate with an absence of analyte, wherein a change in the refractive index indicates the presence of the analyte.

The present disclosure also includes biomedical devices coated with an anti-fouling coating as described herein. In one embodiment, the substrate is formed into a shape of a biomedical device, such as a catheter, and the anti-fouling coating is applied to the substrate forming a catheter with the anti-fouling coating.

In another embodiment, the device is a catheter, a reconstructive or cosmetic elastomer, an elastomer coated metal or ceramic implant, or an implanted biosensor.

In another embodiment, the method for preparing the anti-fouling coating is conducted in a solvent that is compatible with the complementary functional moieties which bond the substrate to the pre-synthesized polymer. For example, in one embodiment, for a click reaction between the substrate and the pre-synthesized polymer, when the substrate is functionalized with a maleimide moiety, and the pre-synthesized polymer functionalized with a thiol moiety, the method is conducted in an aqueous solvent at a pH between about 5.0-7.0, or about 6.0-7.0, wherein the thiol moiety and the maleimide moiety are complementary functional moieties. In another embodiment, when the functional moieties are a radical thiol and an ‘ene moiety, the method is conducted in an oxygen free solvent.

In one embodiment, the physical means comprise mechanically stretching the substrate, inflating the substrate, or by pre-stressing the substrate a thermoplastic film below its glass transition temperature. In another embodiment, the physical means comprise mechanically stretching the substrate through clamping or through applying pressure to or inflating a membrane, or by pre-stressing a thermoplastic film below its glass transition temperature.

The present disclosure discloses a material prepared via the grafting-to method comprising an antifouling surface properties and intrinsic localized surface plasmon resonance (LSPR) sensor capabilities. In one embodiment, a substrate shrinking fabrication method, Graft-then-Shrink, improved antifouling properties of polymer coated Au surfaces by altering graft-to polymer packing while simultaneously generating wrinkled Au structures for LSPR biosensing. Thiol-terminated, antifouling, hydrophilic polymers were grafted to Au coated pre-stressed polystyrene (PS) followed by shrinking upon heating above PS's glass transition temperature. Polymer molecular weight and hydration influenced Au wrinkling patterns. Compared to Shrink-then-Graft controls, where polymers are immobilized post shrinking, Graft-then-Shrink increased polymer content by 76% in defined footprints and improved antifouling properties as demonstrated by 84% and 72% reduction in macrophage adhesion and protein adsorption, respectively. Wrinkled Au LSPR sensors had sensitivities of ˜200-1000 Δλ/ΔRIU, comparing favorably to commercial LSPR sensors, and detected biotin-avidin and desthiobiotin-avidin complexation in a concentration dependent manner using a standard plate reader and 96-well format.

Because antifouling properties of hydrophilic polymer coated surfaces improve with greater polymer surface coverage.⁸ antifouling properties of biointerfaces can be enhanced by combining graft-to polymer coating methods and shrinkable devices. Many medical materials currently in use are shrinkable (e.g., heat shrinkable PTFE⁹), or expandable (e.g., balloon catheters¹⁰). Sensor applications have also leveraged shrinkable substrates to produce flexible wearable electronics,¹¹ stretchable surgical robotics¹² and simplified microfluidics.^{13,14} Shrinking materials to improve fidelity for 3D printing of bioactive nanostructures have also recently drawn attention.¹⁵ Grafting low molecular weight (MW) semifluorinated trichlorosilanes onto mechanically stretched elastomeric substrates has been shown to increase packing density and improve self-assembled monolayer quality for the production of superhydrophobic surfaces.¹⁶

Polymeric surface layers are created by either graft-to or graft-from methodologies. Graft-from polymerization occurs from the device surface to achieve high polymer density but requires complex device manufacturing processes.¹⁸ Graft-to involves a simple fabrication process by immobilizing pre-synthesized polymers on the device surface but results in lower polymer packing densities.¹⁹ Due to manufacturing constraints and complexity of many lab-scale processes, graft-to is the preferred technique and antifouling properties are often sacrificed in produced surfaces.⁶ Therefore, the combination of graft-to and shrinkable materials that do not require surface pre-treatments or complex grafting steps may improve the antifouling properties of manufacturable devices.

Antifouling polymeric coatings are ideal for LSPR biosensors because direct analyte-surface interactions are not required, and the polymer functional groups act as grafting sites for the immobilization of biorecognition and capture agents. LSPR sensors are typically constructed by immobilizing a capture agent directly to Au nanoparticles or a polymeric coating on the nanoparticle surface; capture agent-analyte complexation results in an absorbance peak shift that is measured using specialized optics and light sources.²⁰ Because LSPR's sensing volume extends from the sensor surface (decay length˜5-15 nm²¹), the analyte only needs to interact with immobilized capture agents on the Au surface or within the polymeric layer. Therefore, improving antifouling properties by increasing polymer content within a defined footprint through methods such as Graft-then-Shrink will not interfere with the sensitivity of LSPR biosensors.

### EXAMPLES

The following non-limiting examples are illustrative of the present application:

### Example 1. Results and Discussion

Graft-then-Shrink simultaneously improves fouling properties of polymeric coatings and generates LSPR active surfaces for biosensing using a simple fabrication process by combining graft-to polymer immobilization with shrinking substrates. First, a thin Au layer (<10 nm) was sputtered onto prestressed polystyrene (PS) discs followed by grafting antifouling polymers (thiol-terminated poly(carboxy betaine)²² (PCB) or poly(carboxy betaine-co-N-(3-aminopropyl) methacrylamide) (PCB-co-APMA)) onto the flat Au layer using the graft-to method. Heating above the glass transition temperature of PS shrinks the devices footprint and wrinkles the Au layer,²³ which simultaneously improved polymer packing for enhanced antifouling properties and generated LSPR active surfaces with sensitivities of 200-1000 Δλ/ΔRIU, similar to or greater than current commercial sensors composed of Au nanoparticles (nanoparticle sensitivity 50-100 Δλ/ΔRIU²⁴). This demonstrates shrinking substrates to improve antifouling polymeric coatings on surfaces and the generation of LSPR sensors from wrinkled Au.

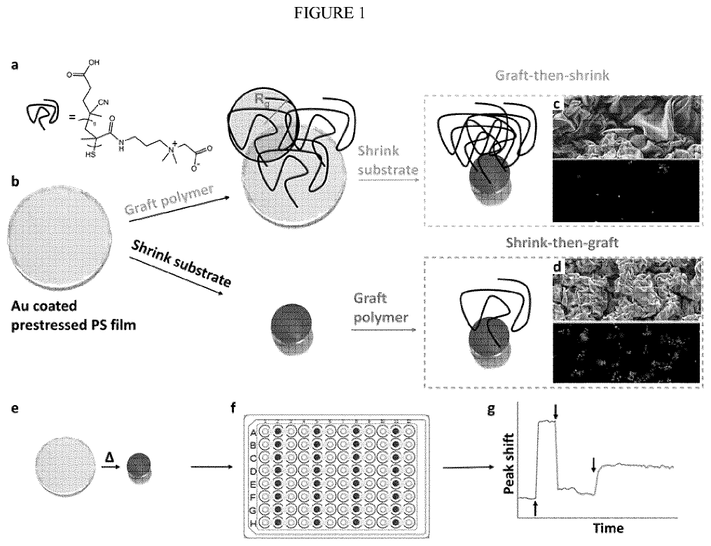

PCB coatings were first investigated on thermally shrunken PS-Au surfaces, where the discs shrunk to ˜16% of their original footprint from 1.39 to 0.23 cm² (FIG. 1) and the Au layer formed micro- and nano-wrinkles (FIG. 1c, d). This level of shrinking is consistent with previous reports using this commercially available PS used for gold sensor applications, and was therefore used for all subsequent experiments²³. The influence of the shrinking/grafting order (Shrink-then-Graft versus Graft-then-Shrink; FIG. 1B) and PCB MW was investigated on the following PS-Au surface properties: (1) PCB content within a defined footprint: (2) Au wrinkling patterns; and (3) macrophage adhesion. Interestingly, Graft-then-Shrink not only improved antifouling properties but also altered the Au film wrinkling patterns compared to Shrink-then-Graft. LSPR sensitivity of the newly formed surfaces was also quantified for potential applications in biosensing by measuring avidin interactions with biotin and desthiobiotin using a 96-well plate and a standard plate reader to track absorbance between 700 to 870 nm over time (FIG. 1f).

The shrinking process can simultaneously produce LSPR sensors by first depositing a thin film of Au or other plasmonic material onto the shrinkable substrate. Upon shrinking, the Au layer forms LSPR active micro- and nano-wrinkles¹⁷ that are exploited here to detect protein interactions by tracking changes in visible light absorbance using a standard plate reader. This represents the first descriptions of substrate shrinking to improve the fouling properties of polymer coatings as well as of Au wrinkled LSPR sensors for the detection of protein interactions. Graft-then-Shrink has the potential to improve antifouling properties for shrinkable or expandable surfaces and simplify the production of antifouling LSPR biosensors.

Graft-then-Shrink increases PCB content within a defined footprint: The degree of shrinking is determined by the stress present in the PS discs: Shrink-then-Graft and Graft-then-Shrink samples therefore have the same final footprint. PCB content on PS-Au shrunken discs was quantified using a colorimetric detection assay for amide bonds and X-ray photoelectron spectroscopy (XPS) to compare the signal due to nitrogen, which are both unique to PCB.

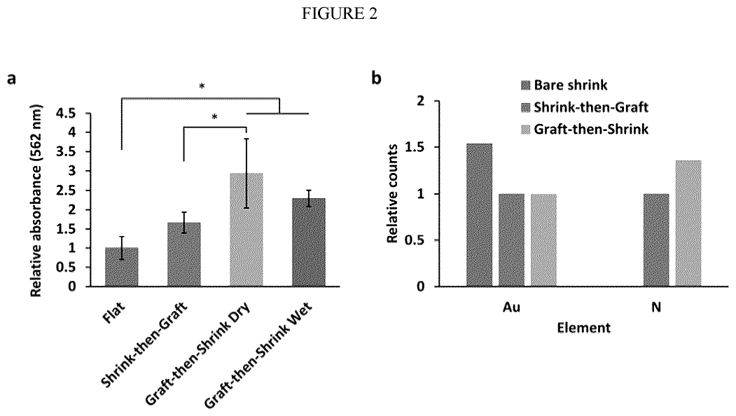

The amount of PCB immobilized on PS-Au discs was quantified by the colorimetric bicinchoninic acid (BCA) assay, which quantitively detects amide bonds (FIG. 1a) in polymers and protein through the reduction of Cu²⁺ in alkaline solutions. To validate the assay, it was first confirmed that absorbance changes within the BCA assay were linearly dependent on PCB concentration in solution. Graft-then-Shrink dry surfaces with 60 kDa PCB resulted in an absorbance signal 2.9× greater than flat (unwrinkled) surfaces (FIG. 2a) with the same footprint, and 1.76× greater than Shrink-then-Graft surfaces indicating an increased polymer content on Graft-then-Shrink surfaces. Shrink-then-Graft surfaces showed increased absorbance compared to flat, but the difference was not statistically significant (adjusted p value 0.28). Performing shrinking of Graft-then-Shrink surfaces in both dry and wet conditions produced similar BCA signals, indicating little influence of humidity on PCB-S—Au bond stability. Polymers immobilized to Au surfaces by S—Au have previously been shown to withstand autoclaving²⁵ but under vacuum conditions S—Au bound polymer stability was found to be side chain dependent at temperatures similar to those used here²⁶. XPS was used to characterize the elemental composition of 60 kDa PCB layers on flat and wrinkled surfaces. XPS showed decreased Au content on PCB coated surfaces compared to bare Au as the PCB layer limited the penetration depth for XPS detection. To directly compare PCB content, the relative nitrogen signal was measured because the atom is unique to PCB in the PS-Au discs. Graft-then-Shrink surfaces had ˜1.36× the nitrogen content of Shrink-then-Graft surfaces (FIG. 2b), in agreement with the BCA results discussed above. Because the XPS spot size was equal for all conditions, the greater PCB content represents an increased density within the surface volume of the Graft-then-Shrink surfaces.

Compared to Shrink-then-Graft, Graft-then-Shrink can increase immobilized polymer content within a footprint by improving accessibility of the reactive surface (e.g., Au) due to surface topography, steric hindrance between polymer chains, and polymer coating rearrangements. Polymer density from the Shrink-then-Graft method will be limited by the polymer's radius of gyration, as the procedure is akin to grafting-to methods.¹⁹ Whereas Graft-then-Shrink increases Au and thereby polymer content per footprint compared to flat surfaces. These results demonstrate that grafting PCB on flat Au surfaces followed by wrinkling enhances polymer content within a defined footprint by ˜75% compared to PCB immobilization on pre-wrinkled substrates and ˜200-300% compared to flat (unwrinkled) surfaces according to the BCA assay. To directly compare apparent chain density between Graft-then-Shrink and Shrink-then-Graft surfaces, grafted fluorescently labelled 60 kDa PCB-co-APMA was quantified to yield 0.02±0.01 chains per nm² for Shrink-then-Graft and 0.11±0.03 chains per nm⁻² for Graft-then-Shrink surfaces. Although Graft-then-Shrink improves polymer content within a footprint, it does not result in brush regimes similar to graft-from upon surface wrinkling. In comparison, Michalek et al. has reported greater grafting densities of 0.17-0.32 chains nm⁻² for poly(2-(methacryloyloxy)ethyl phophorylcholine) (PMPC, a zwitterionic polymer of similar side chain length and MW to PCB-co-APMA) films prepared via surface initiated ATRP.

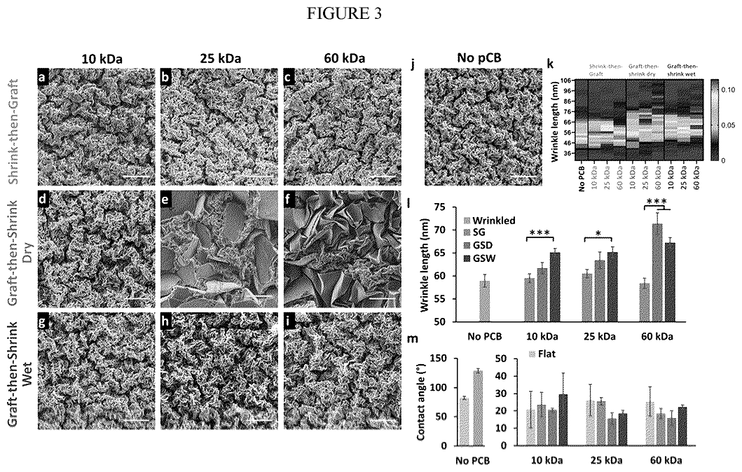

Influence of grafted polymers and shrinking conditions on Au wrinkled structures: the presence, MW, and hydration of grafted PCB influenced Au wrinkling patterns with the formation of large, unwrinkled regions apparent in SEM micrographs of Graft-then-Shrink dry surfaces. As expected, samples wrinkled in the absence of grafted PCB, i.e., PS-Au discs without PCB and Shrink-then-Graft discs, had similar Au wrinkle patterns as shown by SEM and wrinkle length calculations (FIG. 3a-c, j). Conversely, SEM characterization of Graft-then-Shrink dry surfaces with 25 and 60 kDa PCB showed increased heterogeneity in Au layer wrinkled pattern sizes with islands of large micron-scale wrinkles surrounded by nano-scale wrinkling (FIG. 3e, f). These unique wrinkled Au structures may indicate increased film stiffness, as the modulus of the rigid skin material determines the wrinkle size.^{27,28} which may be due to interchain polymer interactions during the shrinking process. No change in Au wrinkling was observed on the 10 kDa PCB Graft-then-Shrink discs, indicating a reduced impact from polymer interchain interactions on stiffness due to the polymer's smaller MW. The observed morphology differences in wrinkle length and generation of large flat regions in Graft-then-Shrink samples is in agreement with the increased polymer content found by BCA and XPS (FIG. 2) and suggests polymer-polymer interactions on the surfaces during shrinking. The influence of the polymer film on sub-micron wrinkles was dependent on a combination of fabrication order, polymer MW and hydration. Micron-scale features did not appear when Graft-then-Shrink surfaces were shrunk with a hydrated polymer layer using an autoclave (Graft-then-Shrink wet), suggesting a decreased polymer film stiffness due to polymer hydration (FIG. 3h, i). Therefore, Graft-then-Shrink wet will produce Au wrinkling patterns with greater uniformity than Graft-then-Shrink dry. Bare wrinkled 5 nm Au produced wrinkle wavelengths 9% smaller than those predicted by theory (eq. S1) (actual=59, predicted=64)²⁹, suggesting the sputtered Au films were slightly thinner than expected (4.6 nm vs 5 nm). Outside of the large flat microstructures observed in Graft-then-Shrink dry, all Graft-then-Shrink surfaces had larger wrinkle sizes (dry: 61±1 nm to 71±2 nm, wet: 65±1 nm to 67±1 nm) compared to bare (59±1 nm) and Shrink-then-Graft surfaces (58±1 nm to 61±1 nm), further demonstrating the influence of the polymer film on wrinkle size (FIG. 3k, l). The heterogeneous structures which arise on the Graft-then-Shrink dry surfaces could be due to the increased interactions between PCB polymers in the dry state where overlapping zwitterionic moieties could exhibit strong electrostatic associations, as previously reported in hydrogels, increasing stiffness locally.³⁰. Polymer MW had an increased influence on wrinkle patterns for Graft-then-Shrink dry than for wet, which is expected as hydration would decrease the mechanical strength of the polymer film.³¹ Moreover, higher MW polymers would be expected to increase the mechanical strength of polymer films in the dry state and therefore alter wrinkling patterns. The relative uniformity of the increased wrinkle lengths in the Graft-then-Shrink wet conditions suggest that immobilized polymers evenly coat the surface.

All surfaces modified had low water contact angles (WCAs) irrespective of MW due to the PCB's hydrophilicity (FIG. 3m). For 10 and 60 kDa PCB, no differences were observed between Graft-then-Shrink, Shrink-then-Graft or unwrinkled Au controls. Surfaces with 25 kDa PCB demonstrated lower WCAs with Graft-then-Shrink (15°±3) than Shrink-then-Graft (25°±2) or unwrinkled Au (26°±9). All PCB coated wrinkled surfaces maintained the hydrophilic nature of the flat coated surfaces, or improved upon it, in contrast to the dramatic increase in hydrophobicity of uncoated wrinkled Au (WCA=129°±4, FIG. 3m). The Graft-then-Shrink method only showed a small decrease in WCA for the 60 kDa PCB polymer when compared to the Shrink-then-Graft but both approached the lower limit of 15° for most PCB surfaces, indicating good surface coverage or increased film thickness due to the polymer's high MW. For 10 kDa PCB surfaces, no decrease in WCA was observed for either shrinking method when compared to non-shrunken surfaces. The polymer was most likely too small for a meaningful increase in apparent polymer density even upon shrinking. All PCB coated surfaces had WCAs between 15.4 and 29.5°, none of which were significantly different from previously reported WCAs of PCB with a carbon spacer length of 1, of 17°±332 (p=0.22, One-way ANOVA with Bonferroni post-hoc test comparing all pairs of columns), making it difficult to compare WCAs due to high variance of flat and 10 kDa PCB coated surfaces. Flat PCB coated surfaces, and surfaces coated with 10 kDa PCB, had much higher variance than all wrinkled surfaces coated with PCB of 25 or 60 kDa (Figure S5), indicating improved consistency in coverage with higher molecular weights and on roughened surfaces, which are known to intensify hydrophilic contact angles³³.”

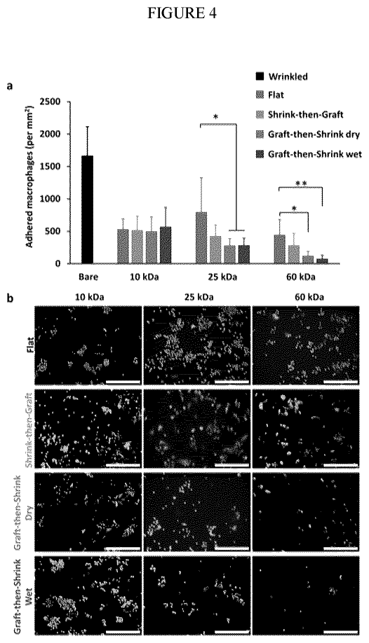

Graft-then-Shrink enhances PCB coated surface resistance to macrophage adhesion: Graft-then-Shrink surfaces had lower nonspecific macrophage adhesion compared to PCB coated flat or Shrink-then-Graft surfaces. Because PCB coated surfaces made from traditional graft-to procedures are already antifouling, we used high fouling experimental conditions to differentiate the fouling rates. To this end, the surfaces were soaked in 100% aged bovine serum for 48 hours for maximum nonspecific protein adsorption, followed by macrophage exposure for 24 hours. Graft-then-Shrink with 25 and 60 kDa PCB improved resistance to macrophage adhesion, whereas 10 kDa PCB did not (FIG. 4). Therefore, smaller polymers (e.g., 10 kDa PCB) are likely too small to sufficiently enhance surface coverage upon shrinking of the PS discs and Au wrinkling, while larger polymers (e.g., 60 kDa PCB) can increase polymeric surface coverage to aid in the resistance of macrophage adhesion. Although a lower cell fouling trend was observed for 25 kDa PCB when comparing Shrink-then-Graft to Graft-then-Shrink, the differences were not statistically significant.

Au wrinkling is not responsible for the improvement of fouling properties, though structured surfaces can reduce and direct cell adhesion.³⁴ Compared to flat (non-shrunk, non-wrinkled) Au surfaces for both 25 and 60 kDa PCB, only Graft-then-Shrink, and not Shrink-then-Graft, surfaces were significantly different. Furthermore, no significant difference in macrophage adhesion was observed between Graft-then-Shrink dry and wet, which indicates that differences in wrinkle length and topography (FIG. 3k) did not significantly influence adhesion here. Therefore, the lower fouling properties of Graft-then-Shrink are mainly due to the increased PCB content per footprint over Shrink-then-Graft surfaces.

Improvement in macrophage adhesion resistance from Graft-then-Shrink is dependent on PCB MW and WCA, which correspond to PCB content. The lowest macrophage adhesion condition was Graft-then-Shrink with 60 kDa PCB in either the dry or wet condition (120 cells±70 per mm2 and 70 cells±60 per mm²), where shrinking occurs with a dry or hydrated PCB layer, respectively. 60 kDa PCB will result in greater surface coverage and polymer layer thickness, as demonstrated by greater polymer content within a defined footprint: polymer layer thickness alone may not significantly improve fouling as demonstrated by comparing 10 and 60 kDa on flat surfaces. 25 kDa and 60 kDa PCB with Graft-then-Shrink led to a 65% and 84% reduction in total cells compared to flat surfaces coated with the same polymers, while the same polymers on Shrink-then-Graft surfaces produced only a 47% and 37% reduction in cells compared to flat surfaces. Therefore, Graft-then-Shrink can improve fouling properties of polymer layers with sufficiently high MWs.

Resistance to bacterial adhesion and bovine serum albumin (BSA) adsorption followed similar trends as macrophage adhesion. For 10 kDa PCB, nonspecific adhesion of P. aeruginosa was lower in Graft-then-Shrink dry and wet conditions with 26.2 and 71.0% reductions compared to Shrink-then-Graft. Larger polymers (e.g., 60 kDa PCB) showed little bacterial adhesion under any conditions (91 to 96% reduction compared to 10 kDa Shrink-then-Graft), making comparisons difficult. Wrinkled Au films with no polymer coating are antifouling towards bacteria due to their extremely hydrophobic surface, which is observed here as well.³⁵ Nonspecific adsorption of fluorescently tagged BSA was also tested and although the Shrink-then-Graft conditions demonstrated high variability, Graft-then-Shrink surfaces trended to lower BSA adsorption for 25 and 60 kDa PCB with a decrease of 71.5 and 72.3%, respectively. Therefore, Graft-then-Shrink can improve resistance to bacterial adhesion and nonspecific protein binding.

Characterization and sensitivity of Graft-then-Shrink LSPR sensors: Graft-then-Shrink offers a simple method to create sensitive LSPR sensors from wrinkled Au surfaces. LSPR active surfaces require curvature of SPR active metals to locally confine surface plasmons, which is traditionally achieved by depositing nanoparticles smaller in size than the plasmon excitation wavelength. More complex and manufacturing intensive LSPR active surfaces can be produced by creating nanostructured arrays using patterning techniques.³⁶ The Au wrinkles on Graft-then-Shrink surfaces confine the surface plasmons for LSPR sensing without the need for nanoparticles, complex deposition techniques, or patterned arrays.

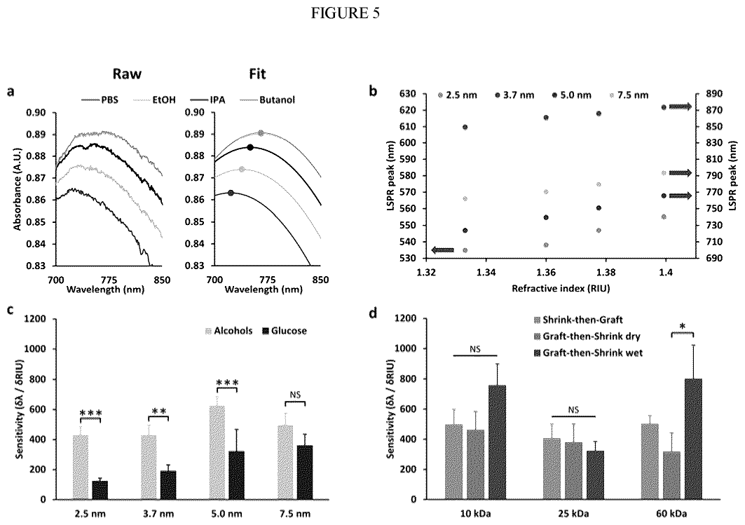

The Au nano- and micro-wrinkles formed upon thermal shrinking of the Au-PS discs produce LSPR activity that is dependent on the refractive index of the sensing volume. To first characterize the sensitivity of bare (no PCB) wrinkled Au surfaces, absorbance measurements of discs with varying initial Au thicknesses in alcoholic and aqueous environments were performed. Sensitivity was determined by the shift in maximum absorbance wavelength (δλ) over the change in the bulk refractive index units of the solution or solvent being measured (δRIU). Ethanol (EtOH), isopropyl alcohol (IPA) and butanol (BuOH) were chosen as solvents because of their defined refractive indices, ability to wet the hydrophobic uncoated wrinkled Au, and their compatibility with the PS disc, allowing for full sensor immersion. The maximum absorbance wavelength increased linearly with refractive index of the solvent (FIG. 5a, b). Au thickness, which determines wrinkle length,³⁷ influenced both the sensor's sensitivity (FIG. 5c) and wavelength of peak absorbance (FIG. 5b). Thicker Au layers shifted the peak absorbance range to longer wavelengths, shifting the range from 548-569 nm to 789-834 nm for Au thicknesses of 2.5 and 3.7 nm, respectively, in the solvents tested. Sensitivity of uncoated wrinkled surfaces was greatest for 5 nm Au coatings at over 600 δλ/δRIU in alcoholic solvents: the sensitivity dropped by ˜2× in aqueous glucose solutions (FIG. 5c) most likely due to lower wetting of the uncoated hydrophobic surface.

Sensors coated with hydrophilic PCB have greater sensitivity than bare sensors in aqueous solutions. The sensitivity of PCB coated Au surfaces in glucose solutions of varying concentration and refractive indexes showed sensitivities similar or greater than bare sensors exposed to alcohols (FIG. 5d). The Graft-then-Shrink fabrication method with PCB produces sensors that operate in aqueous environments with sensitivities of 320±120 to 800±200 δλ/δRIU, depending on grafted polymer MW and hydration state, which is similar to sensitivity of many types of LSPR sensors.³⁶ All methods that produce Au wrinkling (Graft-then-Shrink wet/dry and Shrink-then-Graft) will yield LSPR sensors, with no clear obvious bulk sensitivity benefit for any method. No improvement in sensitivity from glucose bulk shifts would be expected from an increase in polymer content.

Capture ligand immobilization and analyte sensing with Graft-then-Shrink sensors: Using the Graft-then-Shrink fabrication method, polymer coated sensors were developed for the immobilization of biotin or desthiobiotin as the capture ligand and detection (sensing) of avidin binding using similar procedures to commercial LSPR sensors where capture ligands are covalently immobilized to polymer coatings, followed by exposure to the corresponding analyte. This is the first demonstration of a wrinkled Au surface as an LSPR sensor for the detection of biomolecules: previous LSPR sensors have been made from nano sized particles, rods, stars, cubes and triangles or nano/micro arrays, which suffer from lower sensitivities or require more complex processing methods.³⁶

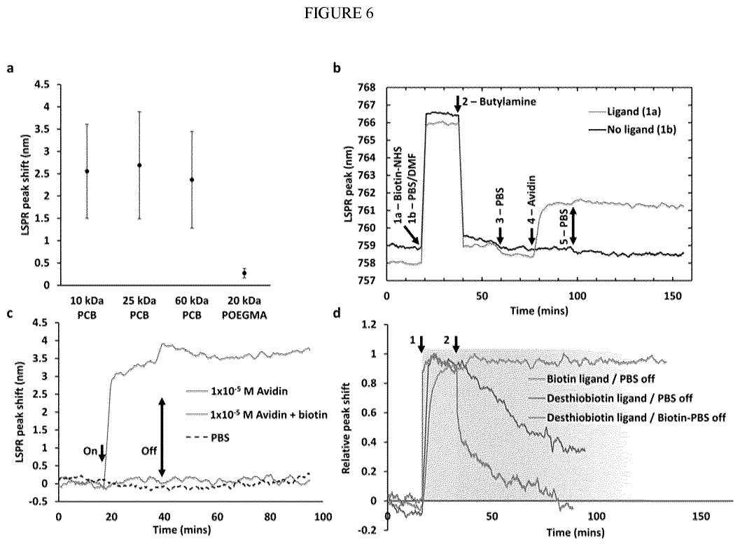

To demonstrate that Graft-then-Shrink (dry) LSPR sensors detect the covalent immobilization of biomolecules, avidin was first immobilized to 10, 25 and 60 kDa PCB coatings using EDC/NHS chemistry. After avidin immobilization, all three MW PCBs showed similar responses with peak shifts of ˜2.5 nm. Poly(oligo (ethylene glycol) methyl ether methacrylate) (POEGMA) coated surfaces had a much smaller shift of ˜0.3 nm post avidin immobilization because each polymer chain only contains one terminal carboxylic acid for conjugation (FIG. 6a). Similar responses from all three PCB MWs suggests that the protein is primarily immobilized on the surface of the polymer layer, with limited penetration. Therefore, the Graft-then-Shrink sensors can detect macromolecules binding to their polymeric coatings like commercial sensors. To improve the efficiency of sensing volume usage, multiple sizes of polymer could be grafted prior to shrinking to produce hierarchical surfaces similar to those previously created by surface-initiated methods.^{32,38,39}

Graft-then-Shrink LSPR sensors successfully detected biotin-avidin interactions as shown by sensorgrams obtained using a standard plate reader. Because the LSPR signal is proportional to the analyte's MW, Au surfaces were modified with a primary amine containing PCB copolymer, PCB-co-APMA (10 kDa, Ð=1.06). The surfaces were then shrunk to produce amine functionalized Graft-then-Shrink sensors for immobilization of NHS-Biotin, the capture ligand (step 1a, red line in FIG. 6b): a large peak shift was observed due to the refractive index of NHS-Biotin's DMF/PBS solution. The activity of PCB-co-APMA conjugated biotin was confirmed using the HABA displacement assay. Sensors were then washed with butylamine to inactivate unreacted NHS-Biotin or residual EDC molecules (step 2), followed by PBS (step 3): the peak shift between step 3 and before step 1a is due to the immobilization of biotin. The sensor was then exposed to an avidin solution in PBS (step 4), and a clear peak shift of ˜3 nm was registered, similar to the covalent avidin immobilization obtained in FIG. 6b (˜2.5 nm). The avidin solution was then removed from the sensor and replaced with PBS (step 5). No decrease in signal was observed because of the long half-life of the biotin-avidin interaction (˜200 d).⁴⁰ A control experiment (black line in FIG. 6b) where the sensor was exposed to a DMF/PBS mixture without NHS-Biotin was conducted to detect nonspecific binding of avidin. After avidin exposure (black line step 4), no peak shift was observed, indicating little to no avidin binding. Graft-then-Shrink sensors can therefore detect the immobilization of biotin and the capture of avidin and are applicable for the detection of specific protein-ligand interactions.

Sensorgrams with avidin and biotin-saturated avidin were then constructed to demonstrate that the biotin-avidin interaction is responsible for the detection signal. Graft-then-Shrink sensors with PCB-co-APMA modified with NHS-biotin were exposed to: 1) 10-5 M avidin pre-saturated with biotin: 2) 10-5 M avidin; and, 3) PBS only. Only the avidin condition produced a significant signal from the complexation of avidin with PCB-co-APMA immobilized biotin (FIG. 6c). Because avidin pre-saturated with biotin cannot bind biotin modified sensor surfaces, the sensorgram signal increase of ˜0.25 nm compared to the PBS only control is due to bulk shifts and nonspecific binding, which is similar to the signal from the bulk shift in RI produced by non-binding protein solutions of BSA at comparable concentrations. The sensors therefore have minimal nonspecific binding, and the signal is due to the specific binding of avidin to surface biotin.

Graft-then-Shrink sensors can also detect dissociation events after the association phase. Graft-then-Shrink sensors with biotin or desthiobiotin immobilized to PCB-co-APMA were fabricated and exposed to avidin solutions. Because of avidin's long half-life with biotin (dissociation rate constant of 7.5×10-8^{s-141}), no peak shift was observed during the dissociation phase of the biotin modified sensor (yellow line in FIG. 6d): the dissociation phase occurs once the avidin solution is removed from the sensor and replaced with PBS buffer. The weaker desthiobiotin-avidin interaction (d-desthiobiotin at pH 7, KD 5×10-13 M VS 1.3×10-15 M)⁴⁰ and greater dissociation rate constant compared to biotin (3.6×10-5 s-1 vs 7.5×10-8 s⁻¹; unmodified desthiobiotin and biotin) allows for avidin dissociation from desthiobiotin modified sensors and acquisition of the dissociation phase once the sensor is in the PBS solution (purple line in FIG. 6d). Modification of desthiobiotin's carboxylic acid, such as in the immobilization technique used here, has been shown to increase its dissociation rate from avidin.⁴⁰ The sensors were placed in a biotin solution to prevent re-association of avidin with surface desthiobiotin during the dissociation phase⁴² (blue line in FIG. 6d), yielding the true dissociation rate of avidin from the sensor surface. Therefore, Graft-then-Shrink sensors can detect both the association and dissociation phase of sensorgrams.

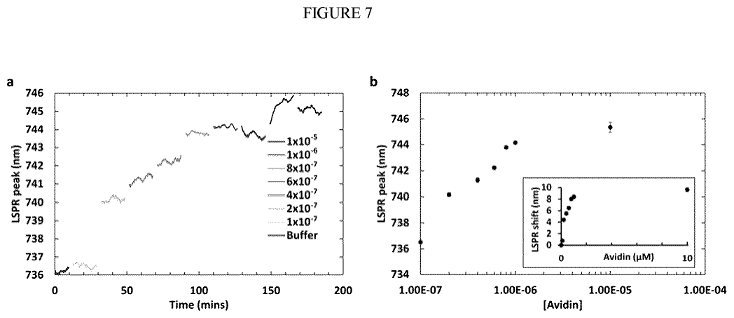

Graft-then-Shrink sensors functionalized with ligand detect analytes in a concentration dependent manner. A biotin modified sensor was sequentially exposed to solutions of increasing avidin concentrations in HEPES (FIG. 7). It should be noted that biotin immobilized to a polymer coating will have a greater KD than free biotin for avidin. A small shift in LSPR peak position was observed at the lowest concentration of avidin (1×10-7 M) when compared to buffer only. More appreciable shifts from 740 to 745 nm at higher concentrations were then observed, with peak positions remaining after avidin removal and exposure to buffer due to the near irreversible nature of the biotin-avidin interaction (FIG. 7A, buffer line without avidin). Concentrations between 2×10⁻⁷ and 1×10⁻⁵ M produced a sigmoidal response (FIG. 7b), which is similar dynamic concentrations ranges reported in previous reports of LSPR sensors with biotin ligands.⁴³ The sensing dynamic range occurs over 2 orders of magnitude, similar to streptavidin binding to immobilized biotin on an LSPR sensor and follows the typical dynamic range of protein-ligand binding curves.⁴³

Enhancing antifouling properties of surfaces remains an active area of research for application in medicine, biosensing and materials exposed to natural elements such as coatings for marine equipment. The method can be extended to other shrinkable, expandable or stretchable substrates, with higher shrinking ratios such as polyolefin,⁴⁴ or elastomeric substrates to produce similarly high-performing surfaces through simple “graft-to” functionalization. For example, Graft-then-Shrink may be applied to many elastomeric implantable biomaterials (e.g., silicone) or marine coatings. Graft-then-Shrink could also be combined with other “graft-to” methods, such as cloud point grafting.⁴⁵ to maximize polymer density. Furthermore, the Graft-then-Shrink method, when applied to thin Au layers with functionalizable polymers, yields highly sensitive biosensors with limited bulk shift and nonspecific binding. This method has been applied for the benchtop production of LSPR biosensors from commonly available and affordable materials, yielding a platform which can be used in a 96 well format within ubiquitously available plate readers, eliminating the need for specialized SPR or LSPR equipment. Graft-then-Shrink sensors may lead to the development of cost-effective, antifouling sensors using simple fabrication techniques for both in vitro and in vivo applications.

### Example 2. Materials and Methods

Materials: N-[3-(dimethylamino)propyl]methacrylamide, tert-butyl bromoacetate, 2,4,6 trinitrobenzene sulfonic acid, trifluoroacetic acid (TFA), 4-Cyano-4-(phenylcarbonothioylthio) pentanoic acid, 4,4-azobis(4-cyanovaleric acid), N-(3-Dimethylaminopropyl)-N′-ethylcarbodiimide hydrochloride (EDC), N-hydroxysuccinimide (NHS), sodium hydroxide, QuantiPro™ BCA Assay Kit, 2-(N-morpholino) ethanesulfonic acid sodium salt (MES), fluorescein sodium salt, n-butanol, isopropyl alcohol, ethanol, sodium acetate, D-(+)-glucose, Poly(ethylene glycol) methyl ether methacrylate (Mn 500), and bovine serum albumin (BSA) were purchased from Sigma Aldrich (Oakville, ON, Canada). Avidin, fetal bovine serum (FBS), and calf bovine serum (CBS) were obtained from Thermo Fisher Scientific (Burlington, ON, Canada). Methanol from Caledon Laboratories (Georgetown, ON, Canada). Pre-stressed polystyrene from Graphix (Maple Heights, OH, USA). Au (99.999%) from LTS Chemical (Chestnut Ridge, NY, USA). Phosphate buffered saline (PBS) at pH 7.4 contained 10 my sodium phosphate and 137 mM NaCl.

Substrate preparation: Prestressed PS shrink film was cleaned by sequential submersion in 2-propanol, ethanol, and DI water for 5 min each with orbital shaking at 100 RPM and dried under nitrogen stream between each step. The PS film was then cut into 1.4 cm diameter discs, which were then sputter coated with Au at 0.3 Å s⁻¹ to final thicknesses of 2.5, 3.7, 5 or 7.5 nm. Following sputter coating, Au coated PS discs (PS-Au) were stored at room temperature.

Carboxybetaine methacrylamide monomer synthesis: Carboxy betaine methacrylamide (CB) monomer was synthesized via a previously published method.⁴⁶ Briefly, 23.25 g of N-[3-(dimethylamino)propyl]methacrylamide was dissolved in 300 mL of dry acetonitrile under nitrogen. Tert-butyl bromoacetate (30 g) was added, and left to react overnight at 50° C. The reaction was cooled to room temperature and the product was precipitated with 500 mL of ether. The product was left to stand at 4° C. overnight, and then decanted. The white powder was collected, washed with 100 mL of ether, decanted, and dried under a stream of nitrogen followed by overnight under vacuum. ¹H NMR (D2O, 600 MHZ) δ: 5.63 (s, 1H), 5.34 (s, 1H), 4.10 (s, 2H), 3.53 (m, 2H), 3.28 (t, J=6.42, 2H), 3.18 (s, 6H), 1.96 (m, 2H), 1.85 (s, 3H).

Synthesis of thiol terminated polycarboxy betaine methacrylamide: Polycarboxy betaine methacrylamide (PCB) polymers at three different molecular weights (10, 25 and 60 kDa) were synthesized. CB monomer (750 mg) was dissolved in 4.2 mL of 2:1 acetate buffer (0.1 M, pH 4.5): 1,4-dioxane. This solution was split into 3 equal parts in 50 mL round bottom flasks and to each 4-Cyano-4-(phenylcarbonothioylthio) pentanoic acid was added (21.56 mg for 10 kDa PCB, 8.48 mg for 25 kDa PCB, 3.51 mg for 60 kDa PCB), following this, 4,4′-Azobis(4-cyanopentanoic acid) was added to each flask (10.81 mg for 10 kDa PCB, 4.25 mg for 25 kDa PCB, 1.76 mg for 60 kDa PCB). Each flask was then degassed by 3 subsequent freeze pump thaw cycles, backfilled with nitrogen gas and left to react at 70° C. for 24 h. The polymerizations were quenched by exposure to air and freezing, and 50 μL of butylamine was added to each flask, pH adjusted to 10 with 8 M NaOH and stirred for 2 h at room temperature to produce thiol-terminated PCB (PCB-SH). Each aminolysed PCB solution was then dialyzed against water for 2 d before the addition of 15 mg of TCEP. Finally, PCB solutions were dialyzed at pH 4 for 3 d and lyophilized to yield a white powder (300-400 mg).

Synthesis of thiol terminated polycarboxy betaine methacrylamide-co-N-(3-aminopropyl)methacrylamide: PCB-co-APMA copolymer containing 30% mole fraction APMA was synthesized as follows: CB monomer (0.7 g), APMA-HCl (0.24 g), and 2,2′-Azobis|2-(2-imidazolin-2-yl)propane]dihydrochloride (3.4 mg) were dissolved in 0.1 M acetate buffer (pH 4.9). Next, 4-Cyano-4-(phenylcarbonothioylthio) pentanoic acid (13.2 mg) was dissolved in 2:1 acetate buffer: 1,4-dioxane and added to the monomer mixture. The pH was adjusted to 4.5 and transferred into a Schlenk flask. The solution underwent three freeze-pump-thaw cycles, followed by five minutes of nitrogen flow, and was immersed into a 40° C. oil bath overnight with gentle stirring. The solution was dialyzed against water adjusted to pH 5 with HCl for 3 d and lyophilized yielding a pink powder. The lyophilized polymer was then aminolysed by dissolving in water adjusted to pH 10 with 8 M NaOH and 50 μL of butylamine and stirred for 2 h at room temperature. The resulting clear solution was dialyzed for 2 d before the addition of 15 mg of TCEP. This solution was then dialyzed for 3 d at pH 5 and lyophilized, yielding a white powder.

Synthesis of thiol terminated poly(oligo ethylene glycol) methyl ether methacrylate: Poly(ethylene glycol) methyl ether methacrylate monomer (1 g) was dissolved in 1.1 mL of 1,4-dioxane. 14.1 mg of 4-Cyano-4-(phenylcarbonothioylthio) pentanoic acid was added, following this, 7.1 mg of 4,4′-Azobis(4-cyanopentanoic acid) was added. The flask was then degassed by 3 subsequent freeze pump thaw cycles, backfilled with nitrogen gas and left to react at 70° C. for 24 h. The polymerization was quenched by exposure to air and freezing, and 50 μL of butylamine was added, pH adjusted to 10 with 8 M NaOH and stirred for 2 h at room temperature to produce thiol-terminated POEGMA (POEGMA-SH). Aminolysed POEGMA was then dialyzed against water for 2 d before the addition of 15 mg of TCEP. Finally, POEGMA-SH was dialyzed at pH 4 for 3 d and lyophilized yielding a clear viscous liquid.

Preparation of Graft-then-Shrink PS-Au-PCB: Thiol terminal PCB (5 mg) was dissolved in 5 mL pH 6.5 MES buffer (10 mM) and incubated with PS-Au discs for 4 d under nitrogen atmosphere, producing “No Shrink” PS-Au-PCB. The surfaces were rinsed with DI water and subsequently, “No Shrink” PS-Au-PCB discs were incubated at 130° C. for 15 min to shrink the PS substrate, producing “Graft-then-Shrink dry” surfaces, or autoclaved in PBS at 121° C. for 15 min producing “Graft-then-Shrink wet” surfaces. Graft-then-Shrink wet surfaces were subsequently rinsed with DI water, dried under a stream of nitrogen, and finally incubated in a 130° C. oven for 15 min to remove cloudiness in PS base from the autoclave procedure.

Preparation of Shrink-then-Graft PS-Au-PCB: PS-Au discs were incubated at 130° C. for 15 min to shrink the PS substrate. These shrunk surfaces were then incubated with thiol terminal PCB-SH (5 mg) in 5 mL pH 6.5 MES buffer (10) mM) and incubated for 4 d under nitrogen atmosphere. Substrates were removed and rinsed with DI water, yielding “Shrink-then-Graft” surfaces.

Polymer characterization by GPC: Polymer molecular weight (Mn, Mw) and dispersity (Ð) was determined by gel permeation chromatography using an Agilent 1260 infinity II GPC system equipped with an Agilent 1260 infinity RI detector, and PL aquagel-OH 30 and PL aquagel-OH 40 (Agilent) columns in series, with PBS running buffer at 30° C. The column was calibrated using polyethylene glycol (PEG) standards (Mn of 3,000 to 60,000).

Characterization of surface hydrophilicity: Static water contact angle measurements were performed with an OCA 20 (future digital scientific) contact angle measurement system and calculated with the SCA 20 software module. 3 μL droplets of MilliQ water (>18.2 MΩ cm resistivity) were deposited on PS-Au and PS-Au-PCB surfaces and photographed. Three droplets were placed at different locations on non-shrunk surfaces and single droplets were placed on shrunk surfaces due to the small size following the shrinking procedure. Three surfaces for each condition were measured.

Scanning electron microscopy: SEM images were acquired with a JSM-7000S SEM (JEOL USA Inc., Peabody, MA, USA). All images were collected with a working distance of (10 mm), accelerating voltage of (3.0 kV) and a probe current setting of “small”. PS-Au discs were attached to the SEM stub via graphite tape and nickel paint was used to connect the Au surfaces to the SEM stub. Length of wrinkles was measured using 100 peak to peak measurements in ImageJ.

Determination of relative polymer content: Graft-then-Shrink and Shrink-then-Graft PS-Au-PCB discs were incubated in a 1:1 solution of DI water and BCA solution prepared according to manufacturer protocols. The discs were incubated for 2 h at 37° C. in a 96 well plate, the discs were then removed from the solution and solution absorbance at 562 nm measured with a Biotek Cytation 5 plate reader.

XPS: Surface elemental composition of PS-Au-PCB60 discs were analyzed with a PHI Quantera II scanning x-ray photoelectron spectroscopy (XPS) microprobe. A 45° take-off angle was used for all samples, pass energy and step size were 55 eV and 0.1 eV for high resolution scans, which were used to determine elemental composition.

Determination of grafting density by fluorescent polymer microscopy: Fluorescein-NHS was synthesized by combining 82.5 mg of fluorescein sodium salt, 21 mg of EDC and 12.6 mg of NHS in 1 mL of PBS at 4° C. and incubating for 1 h. 60 kDa PCB-co-APMA with 5% APMA content was fluorescently labeled with fluorescein-NHS by addition of 50 mg of polymer to previous solution, followed by incubation overnight at 4° C. The fluorescent polymer solution was then centrifuged at 5000 RPM for 5 mins, and the supernatent dialyzed for 3 d against DI water, and freeze dried yielding 40 mg of orange powder. Known masses of PCB-co-APMA labeled with fluorescein were drop cast onto Au discs and shrunk. Shrink-then-Graft and Graft-then-Shrink surfaces were prepared by immersion of the surfaces in 1 mg mL-1 solutions of fluorescent PCB-co-APMA for 4 d. These surfaces were then imaged and surface fluorescence of known mass calibrants were used to determine the mass of polymers on Shrink-then-Graft and Graft-then-Shrink surfaces. The known area of the surfaces and molecular weight of the polymers determined by gel permeation chromatography were used to calculate chains per nm².

Macrophage adhesion: PS-Au-PCB discs were bonded to PS plates with 40 μL of silicone (Sylgard™ 184) and cured at 60° C. for 1 h, then sterilized by incubation with 70% ethanol for 1 h and exposed to UV light for 1 h. Surfaces were then incubated with 100% CBS for 48 h to allow for non-specific protein adhesion to surfaces. Finally, serum was removed, and wells were seeded with 200 μL per 96 well and 1 mL per 24 well, of 50 000 cells mL-1 Raw 264.7 macrophages. Following a 24 h incubation at 37° C. at 5% CO₂, cells were stained with Calcein AM according to manufacturer instructions and imaged with a Biotek Cytation 5 plate reader equipped with a GFP filter cube.

Pseudomonas aeruginosa adhesion: PS-Au-PCB surfaces were immobilized onto glass slides with droplets of silicone (Sylgard 184) and cured at 60° C. for 1 h. All slides were then sterilized via autoclave in sterilization pouches, and then heated at 130° C. for 15 min to remove haze from the PS bases. Pseudomonas aeruginosa (PA01) were incubated in LB at 37° C. until and OD600 of 0.1 was reached. Samples were then incubated for 20 h with P. aeruginosa at 37° C. in LB. The glass slides were then removed from the bacterial suspension and rinsed gently 3 times with room temperature sterile PBS. Bacteria on each surface were then stained with a BacLight kit according to the manufacturer's instructions. A cover slip was taped over the PS-Au surfaces and fluorescence microscopy was performed with a Nikon Eclipse Ti inverted microscope.

LSPR sensitivity measurements: Non-coated PS-Au and coated PS-Au-PCB surfaces were immobilized into a 96 well plate with 40 μL of silicone (Sylgard 184) and cured at 60° C. for 1 h. Each non-coated surface (2.5, 3.7, 5, and 7.5 nm Au thickness) was then exposed to various aqueous solutions of D-(+)-glucose and alcohols (MeOH, EtOH, IPA and n-BuOH), coated pCB-Au-PCB (5 nm Au thickness) surfaces were exposed to D-(+)-glucose solutions only. Absorbance spectra from 300 to 999 nm (1 nm step size) were acquired of each sensor with a Biotek Cytation 5 plate reader. Peaks were then fit to data between 750 and 870 nm with GraphPad Prism 5.

Protein sensing with LSPR surfaces: Avidin detection was performed by immobilizing protein covalently to PCB homopolymer surfaces and through non-covalent avidin-desthiobiotin and avidin-biotin interactions with desthiobiotinylated and biotinylated PCB-co-APMA sensor surfaces. Absorbance was measured in 1 nm intervals from 700 to 870 nm every 9 s with a dBiotek Cytation 5 plate reader for the duration of each reading period.

Covalent protein immobilization: For covalent avidin detection, sensors with PCB coatings were sequentially exposed to PBS (5 mL), EDC (0.1 M) and NHS (0.1 M) in water (1 mL), Avidin (1 μM: 200 μL) in PBS and PBS buffer for 23 minutes each. Sensors were rinsed with sodium acetate buffer (10 mM, pH 4.5) after EDC/NHS step. The immobilization process was tracked by maximum absorbance peak position.

Fluidic device fabrication: Wells were removed from a polystyrene 96 well plate with pliers, and 2 mL of Sylgard 184 PDMS was cured in the well free area to create a flat surface. A 0.54 cm diameter sensor was placed in the location of a well in the 96 well plate and was held in place by curing 2 mL of Sylgard 184 PDMS around the sensor. A slab of PDMS was cured with a 0.6 cm wide channel, an inlet, and an outlet, and adhered over the embedded sensor with a thin layer of PDMS to allow solutions to flow over the sensor surface.

Non-covalent protein sensing: Non-covalent avidin detection was performed similarly to covalent sensing with maximum absorption peak position tracked for 21 minutes for each exposed solution. Sensors with PCB-co-APMA coatings were functionalized with biotin or desthiobiotin prior to exposure to avidin solutions: sensors were exposed to biotin-NHS or desthiobiotin-NHS at 2 mg mL-1 in 4:1 PBS: DMF (1 mL) for 21 minutes, then rinsed with 0.1 M butylamine in PBS (1 mL) to passivate unreacted EDC/NHS. Finally, sensors were flushed with 20 mL of PBS before exposure to analytes.

Statistical analysis: All statistical analyses were performed using GraphPad Prism 8. Significant differences were determined by one-way ANOVA with Bonferroni post hoc test. Significant p-values are indicated on graphs as follows p<0.05 is indicated by * and p<0.01 by **.

### Example 3. Materials and Methods for Swelling

### Materials

N-[3-(dimethylamino)propyl]methacrylamide, tert-butyl bromoacetate, trifluoroacetic acid (TFA), 4-Cyano-4-(phenylcarbonothioylthio) pentanoic acid, 4,4′-azobis(4-cyanovaleric acid), sodium hydroxide, 2-(N-morpholino) ethanesulfonic acid sodium salt (MES), ethanol, sodium acetate, and Poly(ethylene glycol) methyl ether methacrylate (Mₙ=186, 300, and 500), fluorescein methacrylate, fluorescein maleimide assay kit, guanidine hydrochloride, (3-aminopropyl)triethoxy silane (APTES), acetonitrile, and ethyl acetate were purchased from Sigma Aldrich (Oakville, ON, Canada). Fetal bovine serum (FBS), Calcein AM, Hoescht, Sylgard 184 elastomer kit, was obtained from Thermo Fisher Scientific (Burlington, ON, Canada). LB broth was purchased from Bioshop Canada (Burlington, ON, Canada). SMCC was donated by Todd Hoare from McMaster University (Hamilton, ON, Canada). Phosphate buffered saline (PBS) at pH 7.4 contained 10 mM sodium phosphate and 137 mM NaCl.

### PDMS Elastomer Preparation and Swelling

PDMS was prepared using a Sylgard™ 184 elastomer kit, with ratios of 10:1 and 30:1 base to crosslinker. Elastomers were mixed, degassed, and then cured for 30 min at 80° C. Discs of 3 mm thickness and 6 mm diameter were punched out using a leather punch. Discs were then extracted with toluene 4 times to remove uncured free PDMS. Finally, discs were deswelled and stored at room temperature until use.

### Tert-Butyl Protected Carboxybetaine Methacrylamide Monomer Synthesis

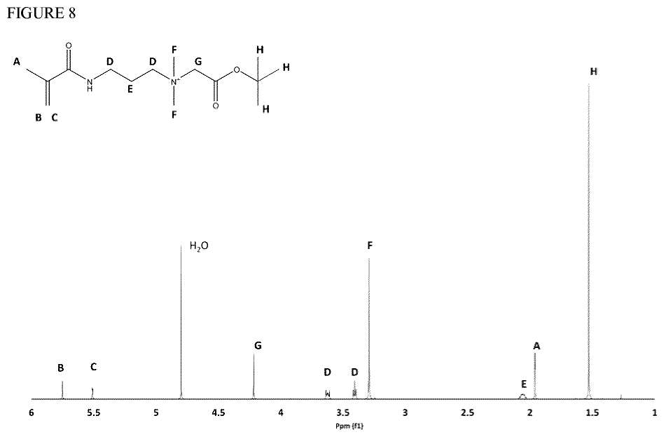

Adapted from previously published procedure⁶⁵, N-[3 (dimethylamino)propyl]methacrylamide (25 g, 147 mmol, 1 equiv.) was dissolved in 200 mL of dry acetonitrile under nitrogen. Tert-butyl bromoacetate (34 g. 176 mmol, 1.2 equiv.) was added, and left to react overnight at 50° C. The reaction was cooled to room temperature and the white product was precipitated with 500 mL of ether, decanted, washed with 100 ml of ether 3 times and dried under a stream of nitrogen. 1H NMR (D2O, 600 MHZ) δ: 5.7 (s, 1H), 5.5 (s, 1H), 4.3 (s, 2H), 3.6 (m, 2H), 3.4 (t, 2H), 3.3 (m, 6H), 2.1 (tt, 2H), 1.9 (s, 3H), 1.5 (s, 9H) (FIG. 8).

### General Polymerization Control

Reaction mixtures for pDMAPMA and pOEGMA homopolymers and pOEGMA-fluorescein and pCB-fluorescein copolymers were prepared for reactions using a RAFT polymerization technique with appropriate amounts of monomer, 4-Cyano-4-(phenylcarbonothioylthio) pentanoic acid chain transfer agent (CTA), 4,4-azobis(4-cyanopentanoic acid) initiator and solvent as detailed in Table 1. Reaction mixtures were then degassed by 3 rounds of the freeze pump thaw method, and incubated, with stirring, at 70° C. overnight. The crude polymer mixtures were then aminolysed by incubation with butylamine (10× CTA mol amount) for 2 h, at pH 10, and finally dialyzed for 3 d against pH 5 water, and lyophilized. Synthesized pDMAPMA was then reacted with tert-butyl bromo acetate at a 3:1 molar excess of TmapBu to DMAPMA monomer content, in acetonitrile for 3 d, and dialyzed against methanol for 3 d to produce pCB-TBu. pCB-TBu was then deprotected by incubation at 50° C. for 6 hours in pH 1.3 HCl, and dialyzed for 3 d against pH 5 water to yield pCB-COOH. Protection and deprotection steps were quantified by H NMR (FIG. 9).

### Polymer Characterization by GPC

Characteristic molecular weights (Mₙ and M_{w}) and dispersities (Ð) were measured by an Agilent 1260 infinity II GPC system equipped with an Agilent 1260 infinity RI detector at 30° C., a Superose 6 Increase 10/300 GL column, and with PBS running buffer supplemented with 0.05% sodium azide at room temperature. The column was calibrated using polyethylene glycol (PEG) standards (Mn of 3,000 to 60,000). Degree of polymerization (N) was calculated using monomer molecular weight and reported measured Mₙ by GPC (Table 2).

### Polymer Grafting Procedure

PDMS discs were plasma oxidized for 45 s on “high” setting, then immediately placed into 1% (v/v) APTES in dry toluene and shaken for 1 h. The APTES solution was then removed, and the discs were rinsed 3 times with dry toluene. A solution of 2 mg mL-1 SMCC in PBS was added to the discs and shaken for 2 h. The SMCC solution was then removed, then discs were dried and either deswelled prior to polymer grafting, reswollen with EtAc or kept swollen in toluene. The discs were then incubated with the appropriate thiol terminated polymer at 2 mg mL⁻¹ in either MES or GHCI buffer at pH 6.5 for 4 d with shaking. Materials that had polymer grafting in the swollen state were then deswelled overnight. Finally, discs were incubated overnight with shaking in pH 9.3 borate buffer to hydrolyze remaining maleimides on the material surface.

### Excess Maleimide Assay

Maleimides on the surface of the PDMS discs were quantified using a modified fluorescence detection assay kit. Fluorescent maleimide reactive probes were prepared according to the manufacturer guidelines and 100 μL of fluorescent probe in supplied Assay Buffer was added to a well containing a PDMS disc to be assayed and incubated at room temperature overnight, with shaking. Each disc was then rinsed 3 times with DI water, dried with a laboratory wipe, and surface fluorescence was quantified by fluorescence microscopy using a Biotek Cytation5 plate reader equipped with a GFP channel filter cube.

### Fluorescent Polymer Content Characterization

Fluorescent polymer distribution into modified elastomers was characterized by confocal laser scanning microscopy depth profiles Z-stacks corresponding of the fluorescein tagged copolymers were acquired at a step size of 10 μm.

### Characterization of Surface Hydrophilicity

Material hydrophilicity was characterized by static water contact angle measurements (OCA 20 contact angle goniometer, with SCA 20 software). Droplets of MilliQ water (2 μL, resistivity>18.2 MΩ cm) were placed onto modified PDMS discs and photographed. One measurement per disc was made, replicates represent three separate discs.

### Bacterial Adhesion Assay

A culture of E. coli BL21 was inoculated in LB broth and incubated overnight at room temperate with shaking. The following day, the culture was subcultured and grown to an OD of 0.5 and then 200 μL of this suspension was added to functionalized PDMS discs in a 96 well plate and incubated at room temperature overnight with shaking. The PDMS discs were then removed from the bacterial suspension, rinsed 3 times with sterile LB broth and placed into fresh LB broth to grown overnight. Following overnight incubation, the OD of the LB broth was measured.

### Macrophage Adhesion

PDMS discs were immobilized into a 96 well plate with PDMS (Sylgard™ 184) and cured at 80° C. for 30 mins, then sterilized by incubation with 70% ethanol for 1 h, and rinsed with sterile DI water 3 times. Sterilized materials were then incubated with 100% aged FBS overnight at 37° C. at 5% CO₂ then the serum was removed and the materials were incubated with RAW 264.7 macrophages (10 000 cells per well) for 48 hours 37° C. at 5% CO₂. Following incubation, the cell containing media was removed from the wells, surfaces were gently rinsed a single time with PBS to remove non-adhered cells from the well, and the materials were stained with Hoescht according to the manufacturer protocol prior to imaging with a Biotek Cytation5 microscope.

### Statistical Analysis

All statistical analyses were performed using GraphPad Prism 8. Significant differences were determined by multiple comparisons corrected multiple t-tests, using the Holm-Sidak method. Significant p-values are indicated on graphs as follows p<0.05 is indicated by *, p<0.01 by **, and p<0.001 by ***.

### Results and Discussion

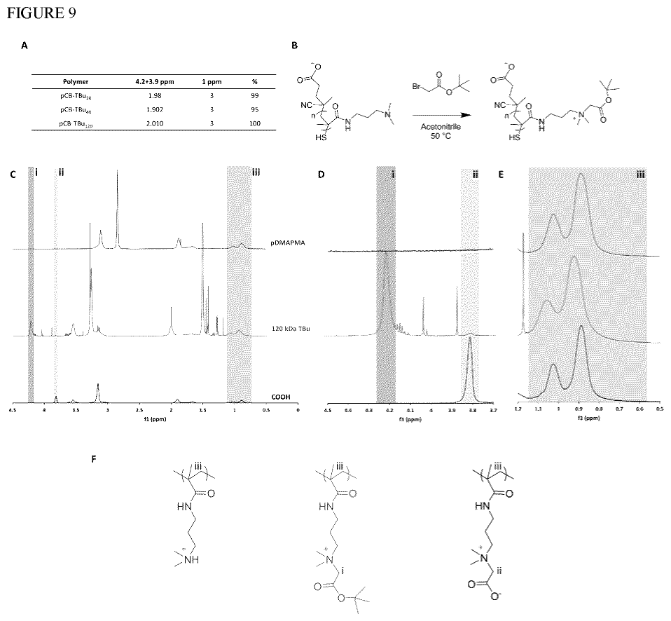

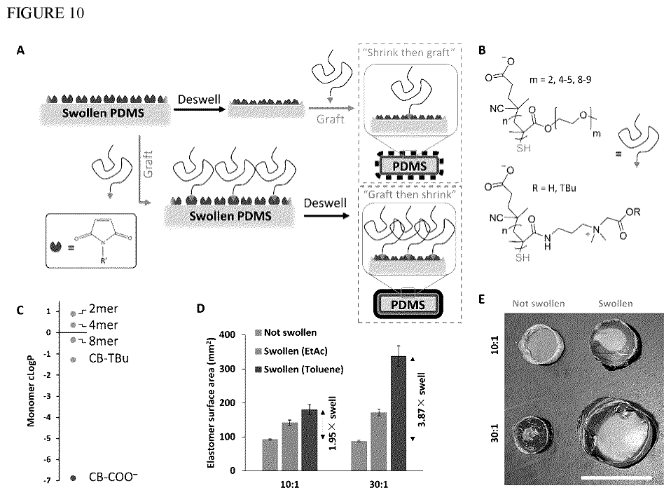

The graft then shrink with substrate swelling increases polymer content on PDMS as shown in FIG. 10.

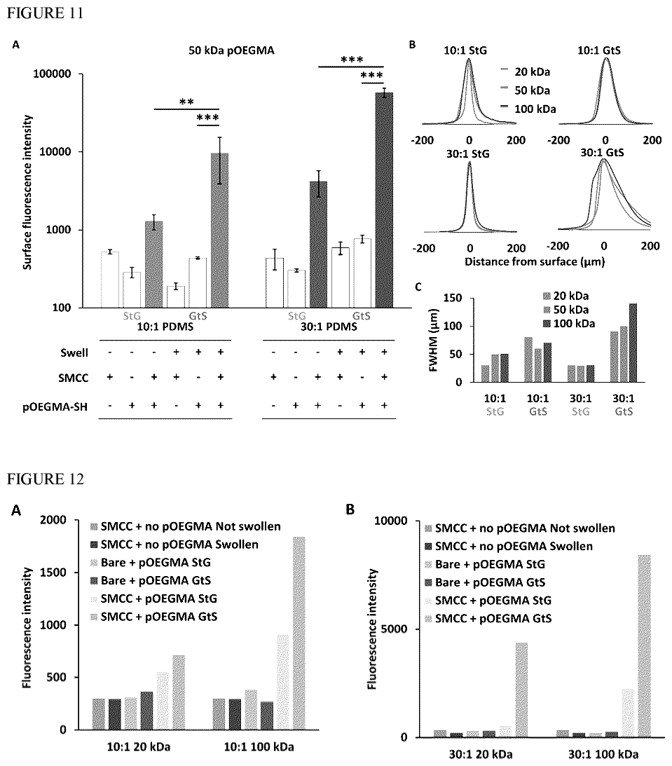

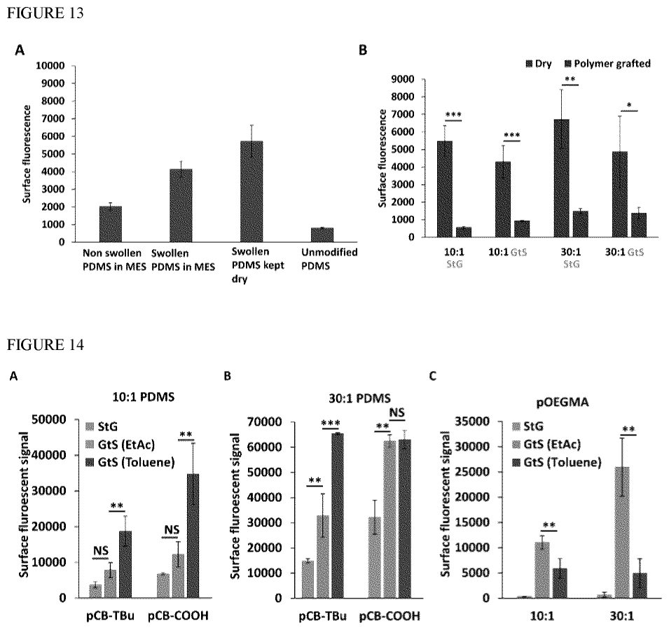

Using fluorescent copolymers (pOEGMA_{f}, PCB-Tbu_{f}, pCB-COOH_{f}) and microscopy characterization, it was found that Graft then shrink improved grafting efficiency by up to 44.9× and 9.4× for pOEGMA_{f} and pCB-COOH_{f}, respectively, which resulted in enhanced polymer mediated properties such as limited fouling rates for pOEGMA based polymers, compared to shrink then graft modified surfaces. For appropriate characterizations and comparisons, samples where polymers were grafted onto swollen PDMS (referred to as “Graft then shrink,” GtS in figures) were compared to control samples where polymers were grafted onto deswelled PDMS (referred to as “Shrink then graft,” StG in figures): all PDMS materials were thoroughly washed before any experiments, to extract free PDMS chains. By using PDMS unreactive to polymers (no maleimide modification), it was determined that polymers did not significantly entangle into the top layer of the PDMS in the swelled state: surfaces with maleimides were required for a significant fluorescent signal (FIG. 11A, FIG. 12). As expected, maleimide content on the PDMS surfaces decreased following the polymer immobilization (FIG. 13), though some maleimide content remained, which was hydrolysed with pH 8.5 borate buffer before conducting nonspecific adhesion assays to avoid covalent maleimide-protein bonding. Therefore, Graft then shrink utilizing swollen PDMS modified with maleimide can enhance thiol-terminated polymer immobilization.

Controlling the PDMS base: crosslinker ratio can control the swelling degree and thus polymer immobilization amount. Swelling increased the grafted pOEGMA_{f} polymer content by 7.5× on the 10:1 PDMS and 13.8× on the 30:1 PDMS compared to respective Shrink then graft controls. When comparing 30:1 to 10:1, 30:1 resulted in 44.9× more polymer content, thus greater swelling (30:1 PDMS) provides increased grafted polymer content over less swelling (10:1 PDMS), though even in the Shrink then graft condition, 30:1 PDMS has greater surface fluorescence than 10:1 PDMS. Confocal microscopy z-stacks showed that all grafted polymer fluorescence was located within the first 200 μm of all PDMS materials studied, with Graft then shrink PDMS having broader grafted polymer distributions (full width at half maximum (FWHM)=60-140 μm) than Shrink then graft (FWHM=30-50 μm) (FIG. 11B, C), likely because of polymer penetration into the swollen PDMS. Increased swelling leads to greater polymer modification of PDMS and a deeper polymer penetration into the first ˜200 μm from the surface.

Besides base polymer content and crosslinking density, grafted polymer content can also be tuned by choice of swelling solvent, as increased solvent mediated swelling of PDMS increased polymer grafting ([0032] FIG. 14A, B). The solvents for swelling PDMS were chosen to have different swelling ratios(S) for PDMS but similar solubility parameters (δ) to best isolate swelling ratio alone (toluene: S=1.31, δ=8.9 cal^{1/2} cm^{-3/2} and ethyl acetate (EtAc): S=1.18, δ=9.0 cal^{1/2} cm^{3/2})+7. The surface fluorescence intensity of the pCB-COOH_{f} and pCB-TBu_{f} modified elastomers was strongly correlated to swelling ratio as mediated by solvent choice (FIG. 14A, B), providing a route to tailor grafted polymer content independent of crosslinker density so that elastomer properties such as stiffness can be partially tailored outside of swelling degree. For example, 10:1 PDMS swelled with toluene and 30:1 PDMS swelled with EtAc have similar swelling ratios (1.95 and 1.96 respectively) but the 30:1 elastomer had 76% more surface fluorescence upon grafting fluorescent pCB-Tbu_{f}. Therefore, PDMS swelling for Graft then shrink applications can be controlled by solvent swelling. crosslinker density or a combination thereof.

The solubility of the graft polymer in the elastomer swelling solvent was investigated with swollen PDMS exposed to pOEGMA_{f} in aqueous MES buffer solutions. EtAc is a good solvent for both PDMS and pOEGMA_{f}, which leads to increased grafted polymer content, compared to toluene which is not able to solubilize the pOEGMA_{f}. Conversely to CB based polymers, 50 kDa 8 mer pOEGMA_{f} had greater fluorescence intensities on EtAc swelled PDMS than on toluene swelled PDMS. Despite the similar 8 of the two solvents, their Log P values differ by almost 2, denoting a near 100× difference in partition (toluene Log P=2.60), EtAc Log P=0.65⁴⁸) between water and octanol. Previously it has been shown that pOEGMA based materials can partition between water and EtAc solvent systems, but not between water and toluene systems, partly explaining improved functionalization with EtAc⁴⁹. Oppositely to pOEGMA, pCB polymers showed greater grafted content when conducted with toluene. This difference in solvent swelling effect between the two polymer types is likely due to the insolubility of pCB polymers in both swelling solvents (EtAC and toluene), and solubility of pOEGMA in the EtAc but not toluene. Solubility of the grafting polymers and PDMS swelling degree must therefore be considered when conducting Graft then shrink PDMS with polymers like pOEGMAs.^{48,49}

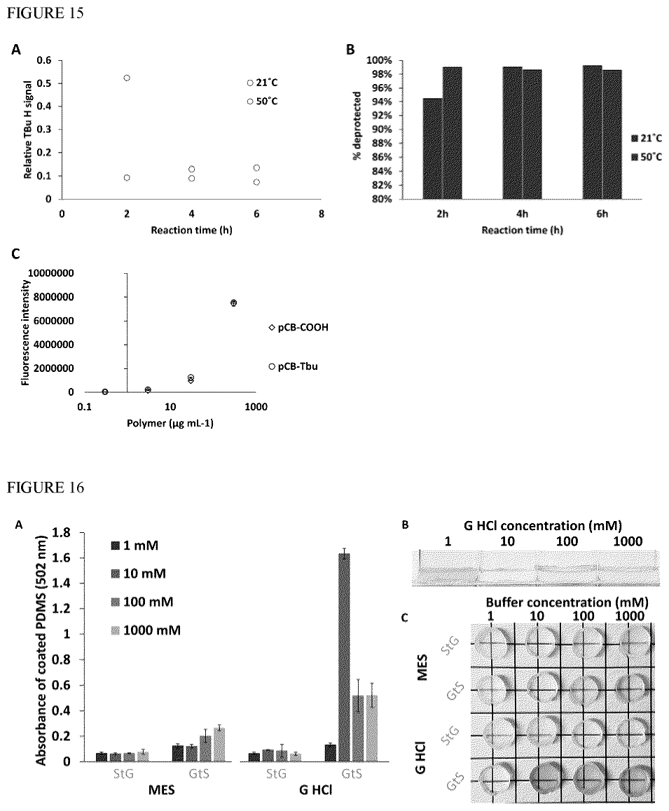

To further illustrate that factors beyond swelling degree and solubility must be considered, we compared the grafting of zwitterionic pCB-COOH, and the positively charged pCB-Tbur_{f}, where, in most conditions, pCB-Tbu resulted in less grafting. Hydrophobicity and total charge influenced polymer immobilization with TBu protected CB based polymers (which are both more hydrophobic and positively charged) producing less surface fluorescent signal than deprotected free carboxylic pCB-COOH_{f}, potentially due to electrostatic repulsion between the polycations ([0032] FIG. 14). It should be noted that the pCB-TBu_{f} and pCB-COOH_{f} fluorescent content was identical as both polymers were sourced from the same batch: pCB-COOH_{f} was produced by deprotecting pCB-TBu_{f} under acid conditions (FIG. 15). As most graft-to procedures, polymer-polymer interactions within the coating influence grafting density.

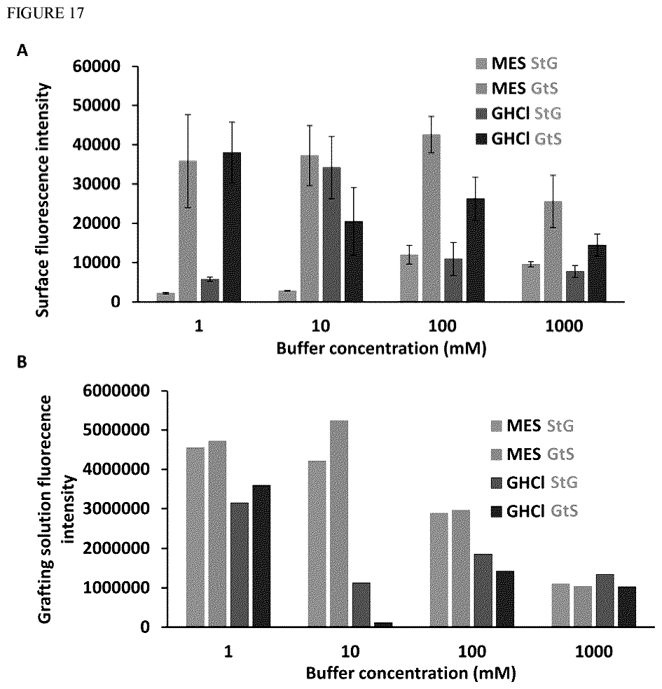

The effect of buffer composition and concentration on grafting density were further investigated using zwitterionic pCB-COOH_{f} given the effects salts exhibit on zwitterion hydration from the antipolyelectrolyte effect⁵⁰. Two grafting buffer compositions were compared, MES and guanidine HCl (GHCl). MES has been previously used in similar applications, and GHCI is a strong chaotrope and guanidine salts have been shown to interact with amide bonds present in the methacrylamide backbone of the pCB-COOH_{f}⁵¹. The incorporation of specific GHCI concentrations enhanced the grafting of pCB-COOH_{f}, with 10 mM GHCI resulting in the greatest grafting degree, whereas MES increased grafting content at higher concentrations ([0034] FIG. 16, FIG. 17). Absorbance of PDMS and the loss of fluorescence from the grafting solution was used to quantify the grafting degree of the pCB-COOH_{f} copolymer: the high grafting density on the PDMS resulted in fluorescence quenching^{52,53} (FIG. 17). Absorbance values at 502 nm were used to quantify polymer content in lieu of fluorescence, where 10 mM GHCI values were the highest overall, with intense absorbance due to fluorescein methacrylate content observed.

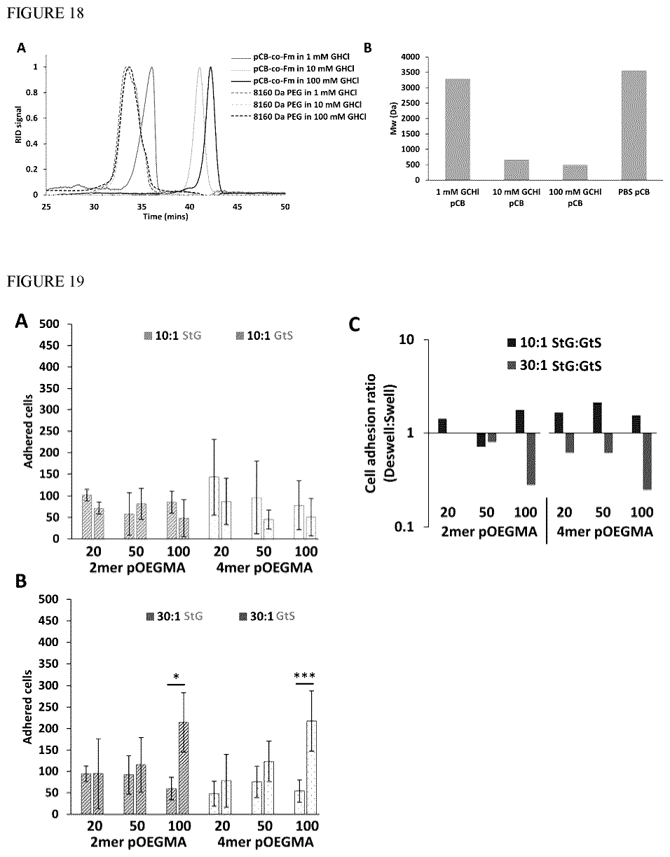

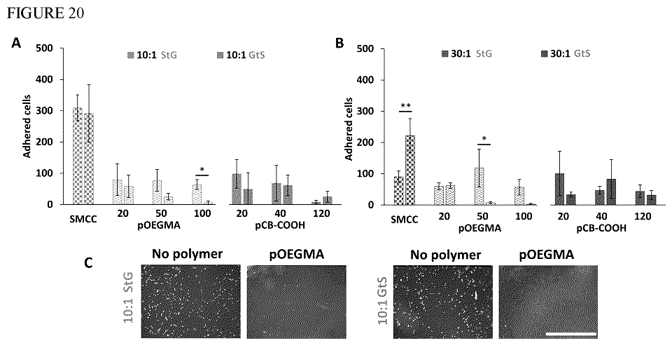

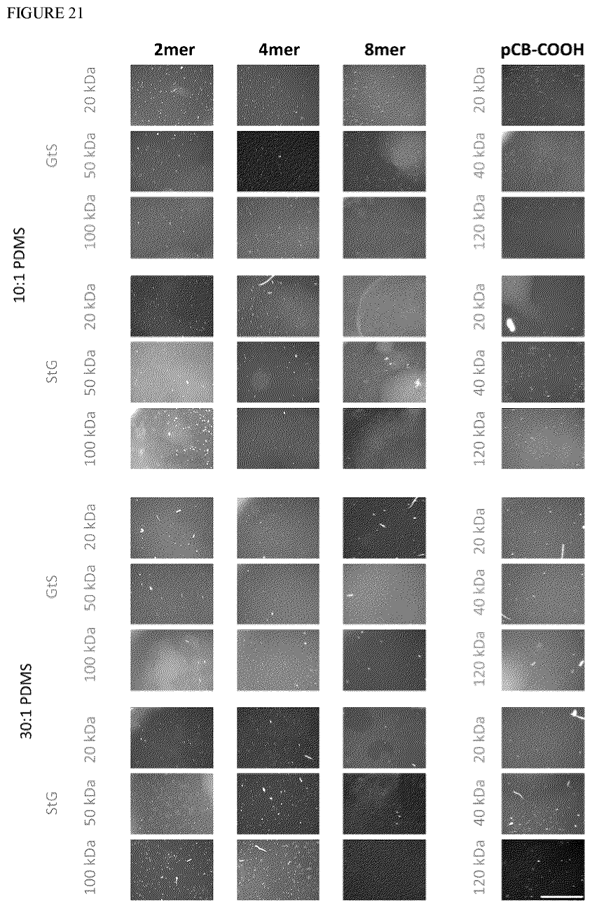

To explore the influence of GHCI on pCB-COOH, we conducted gel permeation chromatography (GPC) studies in buffers containing GHCI. GPC analysis of pCB-COOH in varying GHCI buffer strengths between 1 and 100 mM (pH 6.5) showed decreasing apparent M_{w}s and hydrodynamic radii with increasing buffer concentration, while PEG standards eluted at nearly identical times, with no change in apparent M_{w}, in all three GHCI buffer strengths tested (FIG. 18). Differences in grafting efficiency may be the result of improved polymer packing at 10 mm over 1 mm and improved thiol accessibility and reactivity at 10 mm over 100 mm due to the more extended polymer conformation at 10 mm. Guanidine has previously shown effects on amphiphilic block copolymer grafting density⁵⁴, and has also been shown to control the collapsed and uncollapsed state of elastin like peptides in solution through interactions with amide bonds⁵¹, which are also present in pCB-COOH. Therefore, GHCI is most likely influencing the hydrodynamic radius of pCB-COOH, indicating that buffer conditions beyond solubility can also influence grafting density for zwitterionic polymers.

### Characterization of Biological Fouling Properties

For medical devices to be implanted, the binding of macrophages is an important parameter and metric for relative FBRs. The nonspecific adhesion of RAW 264.7 macrophages to functionalized PDMS was therefore characterized by fluorescence microscopy. Graft then shrink improved the antifouling properties of pOEGMA towards macrophages but not pCB. In all pOEGMA conditions Graft then shrink was equally or more antifouling than Shrink then graft, with 100 kDa POEGMA on 10:1 PDMS reducing adhesion by 98% compared to hydrolyzed SMCC controls and 91% compared to the Shrink then graft condition, with similar improvements on the 30:1 PDMS. Therefore, Graft then shrink is suited for the functionalization of PDMS using pOEGMA polymers, and can improve fouling resistance towards macrophages by up to 98%.

Fouling resistance was found to be Mw dependent, with pOEGMA being most antifouling at the highest studied M_{w}s in the Graft then shrink condition (in agreement with bacterial resistance on pOEGMA presented below). The highest M_{w} pCB-COOH on 10:1 PDMS was also the best performing zwitterion condition, reducing macrophage adhesion by 97% (8±5 cells) compared to hydrolyzed SMCC control, potentially due to a thicker layer being produced at higher M_{w}s, which provides improved antifouling^{55,56}. We have previously seen resistance towards macrophage adhesion to be dependent on polymer molecular weight (M_{w}) for wrinkled gold Graft then shrink surfaces, but no correlation on flat or Shrink then graft was seen⁵⁷. Here, pOEGMA based polymers on both 10:1 and 30:1 PDMS show similar M_{w} dependence on Graft then shrink conditions and not on Shrink then graft surfaces, as expected from previous studies.

As expected, applying the Graft then shrink procedure to pOEGMAs with shorter 2 and 4 repeat unit OEG side chains (i.e., more hydrophobic) enhanced their cell adhesive properties. On the highly swelling 30:1 PDMS, effects of 2 mer and 4 mer pOEGMA are maximized in Graft then shrink conditions, cell adhesive 2 mer and 4-5 mer polymers (m=2 or 4-5 in FIG. 1) increased cell adhesion by 359 and 403% respectively, compared to Shrink then graft (FIG. 19). 10:1 PDMS produced insignificant differences on 2 mer and 4 mer surfaces between Graft then shrink and Shrink then graft, indicating insufficient polymer differences to influence fouling. Graft then shrink can therefore modulate cell adhesive properties in either direction depending on the properties of the polymer to be grafted.

### Nonspecific Bacterial Adhesion

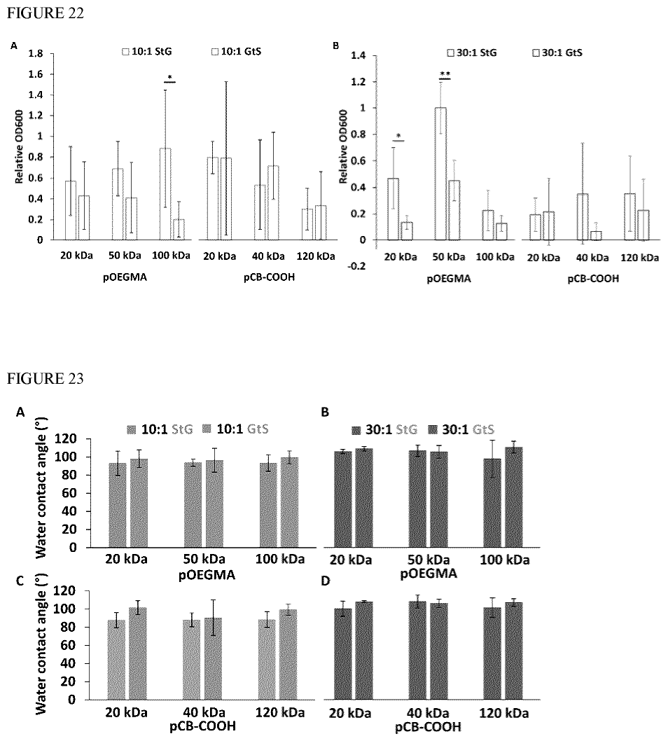

Similar to nonspecific macrophage adhesion, the Graft then shrink protocol consistently reduced the nonspecific adhesion of E. coli to pOEGMA coatings but not pCB. Because the polymer materials used are not antibacterial but are cell repellent, we measured adhesion resistance by live bacterial transfer. To detect small degrees of live bacterial binding. PDMS materials were exposed to bacteria under orbital shaking, then dipped into three sequential sterile LB broth wash containers to remove unbound bacteria and finally incubated overnight in sterile LB growth media before bacterial detection by optical density at 600 nm (OD600). 100 kDa POEGMA Graft then shrink on 10:1 PDMS (OD600)=0.04±0.03) showed the best improvement at resisting E. coli transfer compared to the corresponding Shrink then graft condition (OD600=0.16±0.1: FIG. 22). For bacterial adhesion, no consistent trend was observed between 10:1 and 30:1 PDMS, with increasing pOEGMA M_{w} improving antifouling properties for 10:1 PDMS but not 30:1. Therefore, the Graft then shrink procedure using solvent swelled PDMS is dependent on the grafted polymer type and M_{w} with the antifouling properties of uncharged polymers being improved.

### Physical Characterization of Modified Elastomers

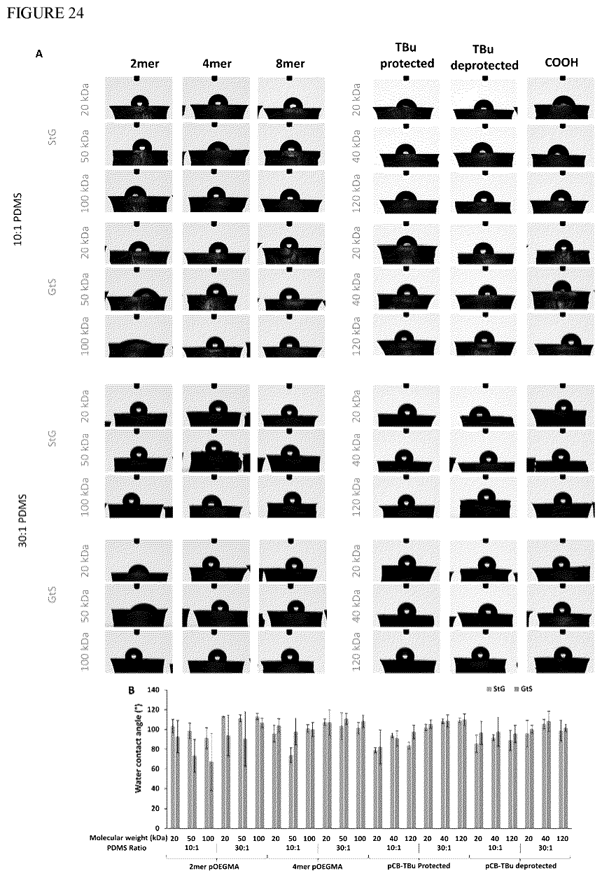

Because water contact angle is often used to predict antifouling properties of surfaces by comparing hydrophilicity, we compared pOEGMA of varying OEG side chain length (2 mer, 4 mer, and 8 mer) and pCB-COOH grafted before and after deswelling. For nearly all polymer compositions. M_{w}s and base ratios. Shrink then graft and Graft then shrink surfaces had statistically similar hydrophilicities. In the water contact angle comparisons. 2 mer modified elastomers were the lone exception with Graft then shrink elastomers displaying increased hydrophilicity compared to Shrink then graft. Interestingly, the traditionally more hydrophobic 2 mer modified PDMS also showed the lowest absolute water contact angle at 67° ([0041] FIG. 23. FIG. 24), despite being the most hydrophobic monomer (c Log P=0.89). Water contact angles (WCA) of graft-from pOEGMA on PDMS have been reported between 54° and 71° depending on layer thickness, appreciably lower than most of the values for pOEGMAs reported here, indicating polymer grafting was either not as dense or as thick as traditional graft-from procedures⁵⁸, even though Graft then shrink enhanced antifouling properties towards macrophages and bacteria for the 8 mer pOEGMA.

The change in WCA between the two conditions is influenced by two variables, the amount of grafted hydrophilic polymer, and the accelerated hydrophobic recovery of the PDMS surface due to the extended solvent swelling in the Graft then shrink state. In the Graft then shrink procedure PDMS was swollen during the 4 d polymer grafting where Shrink then graft was not, which can lead differences in PDMS hydrophobic recovery. To validate if the differences in swelling procedure influences the WCA, we prepared SMCC modified PDMS by Graft then shrink and Shrink then graft without grafting polymers (i.e., exposed swollen and non-swollen SMCC modified elastomers to MES buffer for 4 d). The SMCC modified Shrink then graft surface had lower WCAs (10:1=80°±10, 30:1=105°±3) than SMCC modified Graft then shrink surfaces (10:1=96°±4, 30:1=107°±1), demonstrating that both lower crosslink density and swelling increases hydrophobic recovery. Even though Graft then shrink results in greater polymer immobilization (FIG. 14), Graft the shrink results in higher or similar WCAs for hydrophilic polymers because of accelerated hydrophobic PDMS recovery from solvent swelling compared to Shrink then graft. For hydrophobic polymers (i.e., pOEGMA 2 mer), Graft then shrink decreased WCAs which may be due to hydrophobic POEGMA-POEGMA interactions (lower critical solution temperature of 26° C. for 2 mer) limiting rearrangement at the surface.

The efficiency of the Graft then shrink method is influenced when the properties of the graft polymer—swollen elastomer system are chosen to achieve a solvated reaction environment and a high degree of swelling. The total grafted polymer content was highest when using neutral high M_{w} POEGMAs, coupled with a low crosslink density elastomer, which maximizes swelling, that is swollen with a solvent that also solubilizes the graft polymer. In this case, considering two different measures of hydrophobicity, δ and Log P, allowed the solvent to be matched to the elastomer (δ) for swelling purposes and Log P solvent selection maximized the graft polymer partitioning onto the swollen surface.

The two polymer types investigated here represent two separate classes of hydrophilic antifouling polymer, uncharged, and neutral charged (i.e., zwitterionic). Both polymers prevent protein adsorption via strong interactions with a water shell, but the branched pOEGMA also repels protein through steric repulsion due to the long (Mₙ=500 Da) OEG side chains. These differences in antifouling mechanisms, and the difference in c Log P between the constituent monomers (8-9 mer OEGMA=−0.34, CB=−6.88) may make OEGMA based polymers more amenable to the Graft-then-Shrink method on hydrophobic PDMS and other medically relevant elastomers. Moreover, because Graft then shrink distributed the polymer within the first ˜200 μm, the larger and branched pOEGMAs may improve antifouling activity at the surface through steric repulsion mechanisms.

The Graft then shrink method for swellable elastomeric substrates can be extended to other commonly used medical polymers such as polyurethane or polyvinylchloride⁵⁹. The wide range of relevant swellable materials, growing number of ways to fabricate antifouling polymer films via graft-to, is advantageous for the Graft-then-shrink method. The method could also be used on PDMS with higher swelling ratios such as 60:1 Sylgard™ 184⁶⁰, or on highly stretchable PDMS via mechanical stretching⁶¹ rather than solvent swelling. Grafting of polymers onto swelled elastomers can also be performed using physicochemical methods such as 3,4-dihydroxyphenylalanine (DOPA) anchoring rather than click reactions to expand potential materials for coating⁶². Though click reactions, especially thiol ene reactions, are well suited for Graft then shrink and have been previously explored for the modification of biomaterial surfaces⁶³, due to the simple production of thiol terminated polymers and the catalyst free mild reaction conditions⁶⁴. Finally, the growing array of click reactions allow for the method to be extended to allow for multiple types of polymers to be patterned at once, before shrinking the material to improve final fidelity.

While the present application has been described with reference to examples, it is to be understood that the scope of the claims should not be limited by the embodiments set forth in the examples, but should be given the broadest interpretation consistent with the description as a whole.

All publications, patents and patent applications are herein incorporated by reference in their entirety to the same extent as if each individual publication, patent or patent application was specifically and individually indicated to be incorporated by reference in its entirety. Where a term in the present application is found to be defined differently in a document incorporated herein by reference, the definition provided herein is to serve as the definition for the term.

TABLE 1
Polymerization conditions used for the preparation of RAFT polymer library.

| | Molecular | | | | | |
|---|---|---|---|---|---|---|
| | weight | Monomer | CTA | Initiator | Solvent | Solvent |
| Monomer | (kDa) | (g) | (mg) | (mg) | (mL) | type |
| 2mer | 20 | 2 | 28.3 | 14.2 | 8.7 | Dioxane |
| | 50 | 2 | 11.2 | 5.6 | 8.7 | Dioxane |
| | 100 | 2 | 5.6 | 2.8 | 8.7 | Dioxane |
| 4mer | 20 | 2 | 28.3 | 14.2 | 7.6 | Dioxane |
| | 50 | 2 | 11.2 | 5.6 | 4.7 | Dioxane |
| | 100 | 2 | 5.6 | 2.8 | 7.6 | Dioxane |
| 8mer | 20 | 2 | 28.3 | 14.2 | 3.9 | Dioxane |
| | 50 | 2 | 11.2 | 5.6 | 3.9 | Dioxane |
| | 100 | 2 | 5.6 | 2.8 | 3.9 | Dioxane |
| pOEGMA_{8,9}-fluo | 20 | 0.5/0.004 | 7.1 | 3.6 | 0.98 | Dioxane |
| | 50 | 0.5/0.004 | 2.6 | 1.4 | 0.98 | Dioxane |
| | 100 | 0.5/0.004 | 1.4 | 0.7 | 0.98 | Dioxane |
| pDMAPMA | 20 | 2 | 27.9 | 18.7 | 11 | 2:1 |
| | | | | | | Buffer*:Dioxane |
| | 40 | 2 | 14.0 | 9.3 | 11 | 2:1 |
| | | | | | | Buffer*:Dioxane |
| | 120 | 2 | 4.7 | 3.1 | 11 | 2:1 |
| | | | | | | Buffer*:Dioxane |

*Sodium acetate buffer (pH 5, 1M)

TABLE 2
Calculated molecular weights, dispersities and
degrees of polymerization of polymers used.

| | | Monomer | | | | |
|---|---|---|---|---|---|---|
| Name | | MW | Mₙ | M_{w} | Ð | N |
| 20 kDa | 2mer | 186 | 5.7 | 7.8 | 1.36 | 31 |
| | 4mer | 300 | 7.9 | 9.7 | 1.21 | 26 |
| | 8mer | 500 | 7.8 | 11.1 | 1.41 | 16 |
| 50 kDa | 2mer | 186 | 10.4 | 14.5 | 1.40 | 56 |
| | 4mer | 300 | 16.2 | 27.2 | 1.67 | 54 |
| | 8mer | 500 | 16.9 | 34.5 | 2.04 | 34 |
| 100 kDa | 2mer | 186 | 15.9 | 30.2 | 1.90 | 85 |
| | 4mer | 300 | 44.8 | 112.3 | 2.50 | 149 |
| | 8mer | 500 | 51.3 | 157.8 | 3.07 | 103 |
| pOEDMA_{8,9}-fluo | 20 kDa | 499 | 13.1 | 14.4 | 1.10 | 26 |
| | 50 kDa | 499 | 24.4 | 34.3 | 1.41 | 49 |
| | 100 kDa | 499 | 41.1 | 84.5 | 2.06 | 82 |
| pCB-TBu | 20 kDa | 285 | 16.0 | 23.5 | 1.46 | 56 |
| | 40 kDa | 285 | 33.1 | 83.9 | 2.53 | 116 |
| | 120 kDa | 285 | 122.1 | 409.1 | 3.34 | 428 |

### FULL CITATIONS FOR DOCUMENTS REFERRED TO IN THE APPLICATION

(1) Sundaram, H. S.; Han, X.; Nowinski, A. K.; Brault, N. D.; Li, Y.; Ella-Menye, J. R.; Amoaka, K. A.; Cook, K. E.; Marek, P.; Senecal, K.; Jiang, S. Achieving One-Step Surface Coating of Highly Hydrophilic Poly(Carboxybetaine Methacrylate) Polymers on Hydrophobic and Hydrophilic Surfaces. Adv. Mater. Interfaces 2014, 1 (6), 1-8. https://doi.org/10.1002/admi.201400071.
(2) Sundaram, H. S.; Han, X.; Nowinski, A. K.; Ella-Menye, J. R.; Wimbish, C.; Marek, P.; Senecal, K.; Jiang, S. One-Step Dip Coating of Zwitterionic Sulfobetaine Polymers on Hydrophobic and Hydrophilic Surfaces. ACS Appl. Mater. Interfaces 2014, 6 (9), 6664-6671. https://doi.org/10.1021/am500362k.
(3) Ukita, R.; Wu, K.; Lin, X.; Carleton, N. M.; Naito, N.; Lai, A.; Do-Nguyen, C. C.; Demarest, C. T.; Jiang, S.; Cook, K. E. Zwitterionic Poly-Carboxybetaine Coating Reduces Artificial Lung Thrombosis in Sheep and Rabbits. Acta Biomater. 2019, 92, 71-81. https://doi.org/10.1016/j.actbio.2019.05.019.
(4) Vaisocherová, H.; Brynda, E.; Homola, J. Functionalizable Low-Fouling Coatings for Label-Free Biosensing in Complex Biological Media: Advances and Applications. Anal. Bioanal. Chem. 2015, 407 (14), 3927-3953. https://doi.org/10.1007/s00216-015-8606-5.
(5) Zhang, S.; Geryak, R.; Geldmeier, J.; Kim, S.; Tsukruk, V. V. Synthesis, Assembly, and Applications of Hybrid Nanostructures for Biosensing. Chem. Rev. 2017, 117 (20), 12942-13038. https://doi.org/10.1021/acs.chemrev.7b00088.
(6) Maan, A. M. C.; Hofman, A. H.; de Vos, W. M.; Kamperman, M. Recent Developments and Practical Feasibility of Polymer-Based Antifouling Coatings. Adv. Funct. Mater. 2020, 30 (32), 2000936. https://doi.org/10.1002/adfm.202000936.
(7) Scott, E. A.; Nichols, M. D.; Cordova, L. H.; George, B. J.; Jun, Y. S.; Elbert, D. L. Protein Adsorption and Cell Adhesion on Nanoscale Bioactive Coatings Formed from Poly(Ethylene Glycol) and Albumin Microgels. Biomaterials 2008, 29 (34), 4481-4493. https://doi.org/10.1016/j.biomaterials.2008.08.003.
(8) Banerjee, I.; Pangule, R. C.; Kane, R. S. Antifouling Coatings: Recent Developments in the Design of Surfaces That Prevent Fouling by Proteins, Bacteria, and Marine Organisms. Adv. Mater. 2011, 23 (6), 690-718. https://doi.org/10.1002/adma.201001215.
(9) Bandyopadhyay, S.; Jones, A.; McLean, A.; Sterner, M.; Robbins, C.; Cunningham, M.; Walters, M.; Doddapaneni, K.; Keitel, I.; Gallagher, C. Slippery Liquid Infused Fluoropolymer Coating for Central Lines to Reduce Catheter Associated Clotting and Infections. Sci. Rep. 2020, 10, 14973. https://doi.org/10.1038/s41598-020-71711-6.
(10) Kim, D.-H.; Lu, N.; Ghaffari, R.; Kim, Y.-S.; Lee, S. P.; Xu, L.; Wu, J.; Kim, R.-H.; Song, J.; Liu, Z.; Viventi, J.; De Graff, B.; Elolampi, B.; Mansour, M.; Slepian, M. J.; Hwang, S.; Moss, J. D.; Won, S.-M.; Huang, Y.; Litt, B.; Rogers, J. A. Materials for Multifunctional Balloon Catheters with Capabilities in Cardiac Electrophysiological Mapping and Ablation Therapy. Nat. Mater. 2011, 10 (4), 316-323. https://doi.org/10.1038/nmat2971.
(11) Park, S. J.; Kim, J.; Chu, M.; Khine, M. Highly Flexible Wrinkled Carbon Nanotube Thin Film Strain Sensor to Monitor Human Movement. Adv. Mater. Technol. 2016, 1 (5), 1-8. https://doi.org/10.1002/admt.201600053.
(12) Chang, T.-H.; Tian, Y.; Li, C.; Gu, X.; Li, K.; Yang, H.; Sanghani, P.; Lim, C. M.; Ren, H.; Chen, P.-Y. Stretchable Graphene Pressure Sensors with Shar-Pei-like Hierarchical Wrinkles for Collision-Aware Surgical Robotics. ACS Appl. Mater. Interfaces 2019, 11 (10), 10226-10236. https://doi.org/10.1021/acsami.9b00166.
(13) Grimes, A.; Breslauer, D. N.; Long, M.; Pegan, J.; Lee, L. P.; Khine, M. Shrinky-Dink Microfluidics: Rapid Generation of Deep and Rounded Patterns. Lab Chip 2007, 8 (1), 170-172. https://doi.org/10.1039/b711622e.
(14) Chen, C. S.; Breslauer, D. N.; Luna, J. I.; Grimes, A.; Chin, W. C.; Lee, L. P.; Khine, M. Shrinky-Dink Microfluidics: 3D Polystyrene Chips. Lab Chip 2008, 8 (4), 622-624. https://doi.org/10.1039/b719029h.
(15) Oran, D.; Rodrigques, S. G.; Gao, R.; Asano, S.; Skylar-scott, M. A.; Chen, F.; Tillberg, P. W.; Marblestone, A. H.; Boyden, E. S. 3D Nanofabrication by Volumetric Deposition and Controlled Shrinkage of Patterned Scaffolds. Science (80-.). 2018, 362 (6420), 1281-1285.
(16) Genzer, J.; Efimenko, K. Creating Long-Lived Superhydrophobic Polymer Surfaces through Mechanically Assembled Monolayers. Science (80-.). 2000, 290 (5499), 2130-2133. https://doi.org/10.1126/science.290.5499.2130.
(17) Mousavi M, S. S.; Bicket, I. C.; Bellido, E. P.; Soleymani, L.; Botton, G. A. Electron Energy-Loss Spectroscopy of Surface Plasmon Activity in Wrinkled Gold Structures. J. Chem. Phys. 2020, 153 (22), 224703. https://doi.org/10.1063/5.0031469.
(18) Zoppe, J. O.; Ataman, N. C.; Mocny, P.; Wang, J.; Moraes, J.; Klok, H. Surface-Initiated Controlled Radical Polymerization: State-of-the-Art, Opportunities, and Challenges in Surface and Interface Engineering with Polymer Brushes. Chem. Rev. 2017, 117 (3), 1105-1318.
(19) Michalek, L.; Barner, L.; Barner-Kowollik, C. Polymer on Top: Current Limits and Future Perspectives of Quantitatively Evaluating Surface Grafting. Adv. Mater. 2018, 30 (21), 1-18. https://doi.org/10.1002/adma.201706321.
(20) Chen, Y.; Liu, J.; Yang, Z.; Wilkinson, J. S.; Zhou, X. Optical Biosensors Based on Refractometric Sensing Schemes: A Review. Biosens. Bioelectron. 2019, 144, 111693. https://doi.org/10.1016/j.bios.2019.111693.
(21) Haes, A. J.; Zou, S.; Schatz, G. C.; Van Duyne, R. P. Nanoscale Optical Biosensor: Short Range Distance Dependence of the Localized Surface Plasmon Resonance of Noble Metal Nanoparticles. J. Phys. Chem. B 2004, 108 (22), 6961-6968. https://doi.org/10.1021/jp036261n.
(22) Zhang, Z.; Chen, S.; Jiang, S. Dual-Functional Biomimetic Materials: Nonfouling Poly(Carboxybetaine) with Active Functional Groups for Protein Immobilization. Biomacromolecules 2006, 7 (12), 3311-3315. https://doi.org/10.1021/BM060750M.
(23) Gabardo, C. M.; Zhu, Y.; Soleymani, L.; Moran-Mirabal, J. M. Bench-Top Fabrication of Hierarchically Structured High-Surface-Area Electrodes. Adv. Funct. Mater. 2013, 23 (24), 3030-3039. https://doi.org/10.1002/adfm.201203220.
(24) Jatschka, J.; Dathe, A.; Csáki, A.; Fritzsche, W.; Stranik, O. Propagating and Localized Surface Plasmon Resonance Sensing-A Critical Comparison Based on Measurements and Theory. Sens. Bio-Sensing Res. 2016, 7, 62-70. https://doi.org/10.1016/j.sbsr.2016.01.003.
(25) França, Á.; Pelaz, B.; Moros, M.; Sánchez-Espinel, C.; Hernández, A.; Fernández-López, C.; Grazú, V.; De La Fuente, J. M.; Pastoriza-Santos, I.; Liz-Marzán, L. M.; González-Fernández, Á. Sterilization Matters: Consequences of Different Sterilization Techniques on Gold Nanoparticles. Small 2010, 6 (1), 89-95. https://doi.org/10.1002/smll.200901006.
(26) Chandekar, A.; Sengupta, S. K.; Whitten, J. E. Thermal Stability of Thiol and Silane Monolayers: A Comparative Study. Appl. Surf. Sci. 2010, 256 (9), 2742-2749. https://doi.org/10.1016/j.apsusc.2009.11.020.
(27) Genzer, J.; Groenewold, J. Soft Matter with Hard Skin: From Skin Wrinkles to Templating and Material Characterization. Soft Matter 2006, 2 (4), 310-323. https://doi.org/10.1039/b516741h.
(28) Stimpson, T. C.; Osorio, D. A.; Cranston, E. D.; Moran-Mirabal, J. M. Direct Comparison of Three Buckling-Based Methods to Measure the Elastic Modulus of Nanobiocomposite Thin Films. ACS Appl. Mater. Interfaces 2021. https://doi.org/10.1021/acsami.1c08056.
(29) Chapman, C. T.; Paci, J. T.; Lee, W. K.; Engel, C. J.; Odom, T. W.; Schatz, G. C. Interfacial Effects on Nanoscale Wrinkling in Gold-Covered Polystyrene. ACS Appl. Mater. Interfaces 2016, 8 (37), 24339-24344. https://doi.org/10.1021/acsami.6b08554.
(30) Huynh, V.; Jesmer, A. H.; Shoaib, M. M.; Wylie, R. G. Influence of Hydrophobic Cross-Linkers on Carboxybetaine Copolymer Stimuli Response and Hydrogel Biological Properties. Langmuir 2019, 35 (5), 1631-1641. https://doi.org/10.1021/acs.langmuir.8b03908.
(31) Gill, U.; Sutherland, T.; Himbert, S.; Zhu, Y.; Rheinstädter, M. C.; Cranston, E. D.; Moran-Mirabal, J. M. Beyond Buckling: Humidity-Independent Measurement of the Mechanical Properties of Green Nanobiocomposite Films. Nanoscale 2017, 9 (23), 7781-7790. https://doi.org/10.1039/c7nr00251c.
(32) Jesmer, A. H.; Huynh, V.; Wylie, R. G. Fabrication of Low-Fouling, High-Loading Polymeric Surfaces through PH-Controlled RAFT. RSC Adv. 2020, 10, 20302-20312. https://doi.org/10.1039/d0ra02693j.
(33) Zhang, L.; Zhao, N.; Xu, J. Fabrication and Application of Superhydrophilic Surfaces: A Review. J. Adhes. Sci. Technol. 2014, 28 (8-9), 769-790. https://doi.org/10.1080/01694243.2012.697714.
(34) Nguyen, D. H. K.; Bazaka, O.; Bazaka, K.; Crawford, R. J.; Ivanova, E. P. Three-Dimensional Hierarchical Wrinkles on Polymer Films: From Chaotic to Ordered Antimicrobial
Topographies. Trends Biotechnol. 2020, 38 (5), 558-571. https://doi.org/10.1016/j.tibtech.2019.12.004.
(35) Nguyen, D. H. K.; Pham, V. T. H.; Truong, V. K.; Sbarski, I.; Wang, J.; Balčytis, A.; Juodkazis, S.; Mainwaring, D. E.; Crawford, R. J.; Ivanova, E. P. Role of Topological Scale in the Differential Fouling of: Pseudomonas Aeruginosa and Staphylococcus Aureus Bacterial Cells on Wrinkled Gold-Coated Polystyrene Surfaces. Nanoscale 2018, 10 (11), 5089-5096. https://doi.org/10.1039/c7nr08178b.
(36) Mayer, K. M.; Hafner, J. H. Localized Surface Plasmon Resonance Sensors. Chem. Rev. 2011, 111 (6), 3828-3857. https://doi.org/10.1021/cr100313v.
(37) Fu, C. C.; Grimes, A.; Long, M.; Ferri, C. G. L.; Rich, B. D.; Ghosh, S.; Ghosh, S.; Lee, L. P.; Gopinathan, A.; Khine, M. Tunable Nanowrinkles on Shape Memory Polymer Sheets. Adv. Mater. 2009, 21 (44), 4472-4476. https://doi.org/10.1002/adma.200902294.
(38) Brault, N. D.; Sundaram, H. S.; Huang, C. J.; Li, Y.; Yu, Q.; Jiang, S. Two-Layer Architecture Using Atom Transfer Radical Polymerization for Enhanced Sensing and Detection in Complex Media. Biomacromolecules 2012, 13 (12), 4049-4056. https://doi.org/10.1021/bm301335r.
(39) Huang, C. J.; Li, Y.; Jiang, S. Zwitterionic Polymer-Based Platform with Two-Layer Architecture for Ultra Low Fouling and High Protein Loading. Anal. Chem. 2012, 84 (7), 3440-3445. https://doi.org/10.1021/ac3003769.
(40) Green, M. N. Avidin. Adv. Protein Chem. 1975, 29, 85-133. https://doi.org/10.1007/978-3-540-37885-3_11.
(41) Piran, U.; Riordan, W. J. Dissociation Rate Constant of the Biotin-Streptavidin Complex. J. Immunol. Methods 1990, 133 (1), 141-143. https://doi.org/10.1016/0022-1759 (90) 90328-S.
(42) Hirsch, J. D.; Eslamizar, L.; Filanoski, B. J.; Malekzadeh, N.; Haugland, R. P.; Beechem, J. M.; Haugland, R. P. Easily Reversible Desthiobiotin Binding to Streptavidin, Avidin, and Other Biotin-Binding Proteins: Uses for Protein Labeling, Detection, and Isolation. Anal. Biochem. 2002, 308 (2), 343-357. https://doi.org/10.1016/S0003-2697 (02) 00201-4.
(43) Aćimovic, S. S.; Ortega, M. a: Sanz, V.; Berthelot, J.; Garcia-Cordero, J. L.; Renger, J.; Maerkl, S. J.; Kreuzer, M. P.; Quidant, R. LSPR Chip for Parallel, Rapid, and Sensitive Detection of Cancer Markers in SerumMarkers in Serum. Nano Lett. 2014, 14 (5), 2636-2641.
(44) Nguyen, D.; Taylor, D.; Qian, K.; Norouzi, N.; Rasmussen, J.; Botzet, S.; Lehmann, M.; Halverson, K.; Khine, M. Better Shrinkage than Shrinky-Dinks. Lab Chip 2010, 10 (12), 1623-1626. https://doi.org/10.1039/c001082k.
(45) Kingshott, P.; Thissen, H.; Griesser, H. J. Effects of Cloud-Point Grafting, Chain Length, and Density of PEG Layers on Competitive Adsorption of Ocular Proteins. Biomaterials 2002, 23 (9), 2043-2056. https://doi.org/10.1016/S0142-9612 (01) 00334-9.
(46) Cao, Z.; Yu, Q.; Xue, H.; Cheng, G.; Jiang, S. Nanoparticles for Drug Delivery Prepared from Amphiphilic PLGA Zwitterionic Block Copolymers with Sharp Contrast in Polarity between Two Blocks. Angew. Chemie-Int. Ed. 2010, 49 (22), 3771-3776. https://doi.org/10.1002/anie.200907079. (47) Lee, J. N.; Park, C.; Whitesides, G. M. Solvent Compatibility of Poly(Dimethylsiloxane)-Based Microfluidic Devices. Anal. Chem. 2003, 75 (23), 6544-6554. https://doi.org/10.1021/ac0346712.
(48) Reslow, M.; Adlercreutz, P.; Mattiasson, B. Organic Solvents for Bioorganic Synthesis 1. Optimization of Parameters for a Chymotrypsin Catalyzed Process: 1987: Vol. 26.
(49) Li, D.; Zhao, B. Temperature-Induced Transport of Thermosensitive Hairy Hybrid Nanoparticles between Aqueous and Organic Phases. Langmuir 2007, 23 (4), 2208-2217. https://doi.org/10.1021/la0628165.
(50) Xiao, S.; Ren, B.; Huang, L.; Shen, M.; Zhang, Y.; Zhong, M.; Yang, J.; Zheng, J. Salt-Responsive Zwitterionic Polymer Brushes with Anti-Polyelectrolyte Property. Curr. Opin. Chem. Eng. 2018, 19, 86-93. https://doi.org/10.1016/j.coche.2017.12.008.
(51) Heyda, J.; Okur, H. I.; Hladilková, J.; Rembert, K. B.; Hunn, W.; Yang, T.; Dzubiella, J.; Jungwirth, P.; Cremer, P. S. Guanidinium Can Both Cause and Prevent the Hydrophobic Collapse of Biomacromolecules. J. Am. Chem. Soc. 2017, 139 (2), 863-870. https://doi.org/10.1021/Jacs.6b11082.
(52) Bae, W.; Yoon, T. Y.; Jeong, C. Direct Evaluation of Self-Quenching Behavior of Fluorophores at High Concentrations Using an Evanescent Field. PLOS One 2021, 16 (2 Feb. 2021). https://doi.org/10.1371/journal.pone.0247326.
(53) Besford, Q. A.; Merlitz, H.; Schubotz, S.; Yong, H.; Chae, S.; Schnepf, M. J.; Weiss, A. C. G.; Auernhammer, G. K.; Sommer, J. U.; Uhlmann, P.; Fery, A. Mechanofluorescent Polymer Brush Surfaces That Spatially Resolve Surface Solvation. ACS Nano 2022, 16 (2), 3383-3393. https://doi.org/10.1021/acsnano.2c00277.
(54) Schulze, M.; Adigüzel, S.; Nickl, P.; Schmitt, A. C.; Dernedde, J.; Ballauff, M.; Haag, R. A Simple and Robust Method to Prepare Polyelectrolyte Brushes on Polymer Surfaces. Adv. Mater. Interfaces 2022, 9 (5). https://doi.org/10.1002/admi.202102005.
(55) Yang, W.; Xue, H.; Li, W.; And, J. Z.; Jiang, S. Pursuing “Zero” Protein Adsorption of Poly(Carboxybetaine) from Undiluted Blood Serum and Plasma. Langmuir 2009, 25 (19), 11911-11916. https://doi.org/10.1021/la9015788.
(56) Zhao, C.; Li, L.; Wang, Q.; Yu, Q.; Zheng, J. Effect of Film Thickness on the Antifouling Performance of Poly(Hydroxy-Functional Methacrylates) Grafted Surfaces. Langmuir 2011, 27 (8), 4906-4913. https://doi.org/10.1021/la200061h.
(57) Jesmer, A. H.; Huynh, V.; Marple, A. S. T.; Ding, X.; Moran-Mirabal, J. M.; Wylie, R. G. Graft-Then-Shrink: Simultaneous Generation of Antifouling Polymeric Interfaces and Localized Surface Plasmon Resonance Biosensors. ACS Appl. Mater. Interfaces 2021, 13 (44), 52362-52373. https://doi.org/10.1021/acsami.1c14930.
(58) Mousavi, M.; Ghaleh, H.; Jalili, K.; Abbasi, F. Multi-Layer PDMS Films Having Antifouling Property for Biomedical Applications. J. Biomater. Sci. Polym. Ed. 2020, 32 (5), 678-693. https://doi.org/10.1080/09205063.2020.1856300.
(59) Maitz, M. F. Applications of Synthetic Polymers in Clinical Medicine. Biosurface and Biotribology 2015, 1 (3), 161-176. https://doi.org/10.1016/j.bsbt.2015.08.002.
(60) Glover, J. D.; Mclaughlin, C. E.; Mcfarland, M. K.; Pham, J. T. Extracting Uncrosslinked Material from Low Modulus Sylgard 184 and the Effect on Mechanical Properties. J. Polym. Sci. 2020, 58 (2), 343-351. https://doi.org/10.1002/pola.29558.
(61) Zhou, L. Y.; Gao, Q.; Fu, J. Z.; Chen, Q. Y.; Zhu, J. P.; Sun, Y.; He, Y. Multimaterial 3D Printing of Highly Stretchable Silicone Elastomers. ACS Appl. Mater. Interfaces 2019, 11 (26), 23573-23583. https://doi.org/10.1021/acsami.9b04873.
(62) Sundaram, H. S.; Han, X.; Nowinski, A. K.; Brault, N. D.; Li, Y.; Ella-Menye, J. R.; Amoaka, K. A.; Cook, K. E.; Marek, P.; Senecal, K.; Jiang, S. Achieving One-Step Surface Coating of Highly Hydrophilic Poly(Carboxy betaine Methacrylate) Polymers on Hydrophobic and Hydrophilic Surfaces. Adv. Interfaces Mater. 2014, 1 (6), 1-8. https://doi.org/10.1002/admi.201400071.
(63) Donahoe, C. D.; Cohen, T. L.; Li, W.; Nguyen, P. K.; Fortner, J. D.; Mitra, R. D.; Elbert, D. L. Ultralow Protein Adsorbing Coatings from Clickable PEG Nanogel Solutions: Benefits of Attachment under Salt-Induced Phase Separation Conditions and Comparison with PEG/Albumin Nanogel Coatings. Langmuir 2013, 29 (12), 4128-4139. https://doi.org/10.1021/la3051115.
(64) Kakwere, H.; Perrier, S. Orthogonal “Relay” Reactions for Designing Functionalized Soft Nanoparticles. J. Am. Chem. Soc. 2009, 131 (5), 1889-1895. https://doi.org/10.1021/ja8075499.
(65) Keefe, A. J.; Jiang, S. Poly(Zwitterionic) Protein Conjugates Offer Increased Stability without Sacrificing Binding Affinity or Bioactivity. Nat. Chem. 2012, 4 (1), 59-63. https://doi.org/10.1038/nchem.1213.

1. A method for preparing an anti-fouling polymeric coating on a substrate having a surface area, the method comprising:
a. increasing the surface area of the substrate;
b. functionalizing the substrate with one or more first functional moieties;
c. grafting to the substrate one or more pre-synthesized polymers, wherein the polymer comprises one or more second functional moieties which is complementary to the first functional moiety and reacts to form a bond between the substrate and the polymer, or the polymer and substrate associate through hydrophobic interactions; and
d. reducing the surface area of the substrate thereby increasing the density of the polymers on the substrate,
thereby obtaining the anti-fouling polymeric coating on the substrate.

2. The method of claim 1, wherein the substrate is a crosslinked polymer.

3. The method of claim 2, wherein the crosslinked polymer is an elastomer.

4. The method of claim 2, wherein the elastomer is a siloxane elastomer or a polyurethane elastomer.

5. The method of claim 1, wherein the polymer is an antifouling hydrophilic polymer.

6. The method of claim 1, wherein the substrate comprises polystyrene, polytetrafluoroethylene (PTFE), polydimethylsiloxane (PDMS), polyolefin, low density polyethylene (LDPE), polyvinylchloride (PVC) or polyurethane.

7. The method of claim 1, wherein the surface area of the substrate is increased by physical or chemical means.

8. The method of claim 7, wherein the physical means comprises a mechanically-applied force, wherein the force is stretching the substrate, inflating the substrate, or by pre-stressing the substrate below its glass transition temperature.

9. The method of claim 7, wherein the chemical means comprise swelling the substrate in a suitable solvent.

10. The method of claim 9, wherein the suitable solvent is an organic solvent capable of dissolving or swelling the elastomer.

11. (canceled)

12. The method of claim 7, wherein the degree of surface area increase is controlled by the solvent, the degree of cross-linking of the substrate, or amount of physical stretching.

13. The method of claim 1, wherein the first functional moiety comprises a thiol reactive plasmonic metal or a chemical moiety comprising a vinyl moiety, an amine moiety, an alkyne moiety, an azide moiety, or a maleimide moiety.

14. The method of claim 1, wherein the first functional moiety comprises a hydrophobic surface amenable to physisorption of DOPA.

15. The method of claim 13, wherein the thiol reactive plasmonic metal is gold, silver or platinum.

16. The method of claim 1, wherein the pre-synthesized polymer is zwitterionic polymer or a hydrophilic polymer.

17. The method of claim 16, wherein the zwitterionic polymer is (poly(carboxybetaine) (PCB), polysulfobetaine, poly(2-methacryloyloxyethyl phosphorylcholine), poly(2-methacryloyloxyethyl phosphorylcholine) (PMPC), or poly-trimethylamine (N-oxide).

18. The method of claim 16, wherein the hydrophilic polymer is poly(ethylene glycol) (PEG), or poly(oligo(ethyleneglycol)methylethermethacrylate) (POEGMA).

19. (canceled)

20. The method of claim 1, wherein the second functional moiety is a thiol, 3,4-dihydroxyphenylalanine (DOPA), N-hydroxysuccinimide ester, an azide moiety, or alkyne terminated functional group.

21. The method claim 7, wherein the surface area of the substrate is reduced by heating the substrate above the glass transition temperature or removing the mechanically applied force.

22. The method of claim 8, wherein when the substrate is swelled with a solvent, the surface area of the substrate is reduced by evaporation or exchange of the solvent.

23. (canceled)

24. The method of claim 1, wherein the substrate is polystyrene and the polystyrene is functionalized with a film of gold, and upon heating the polystyrene above its glass transition temperature, the film of gold wrinkles to form active micro and nano-wrinkles thereby increasing the density of the polymers on the substrate.

25.-27. (canceled)
